(19) United States
(12) Patent Application Publication
(10) Pub. No.: US 2025/0189827 A1
(43) Pub. Date: Jun. 12, 2025

(54) APPARATUSES AND METHODS FOR OPTICAL SYSTEMS

(71) Applicant: Meta Platforms Technologies, LLC, Menlo Park, CA (US)

(72) Inventors: Gang Chen, San Jose, CA (US); Ahmet Tura, Redmond, WA (US); Suhui Lee, Santa Clara, CA (US); Gyungmin Kim, Santa Clara, CA (US); Tao-Hua Lee, Sunnyvale, CA (US); Cheonhong Kim, Mountain View, CA (US); Yung-Yu Hsu, San Jose, CA (US); Min Hyuk Choi, San Jose, CA (US); Amir Amirkhany, Los Altos Hills, CA (US); Yu Li, Bellevue, WA (US); Rongzhi Huang, Sammamish, WA (US); Sawyer Miller, Bellevue, WA (US); Zhenye Li, Redmond, WA (US); Junren Wang, Redmond, WA (US); Redeen Alexandre E Mendoza Duran, Seattle, WA (US); Khalid Omer, Kirkland, WA (US); Weihan Zhang, Redmond, WA (US); Mantas Zurauskas, Redmond, WA (US); Scott Charles McEldowney, Redmond, WA (US); Lu Lu, Kirkland, WA (US); Brian Schowengerdt, Seattle, WA (US); Jun Yan, Redmond, WA (US); Michal Makowski, Kirkland, WA (US)

(21) Appl. No.: 18/968,412

(22) Filed: Dec. 4, 2024

Related U.S. Application Data
(60) Provisional application No. 63/606,765, filed on Dec. 6, 2023.
(60) Provisional application No. 63/560,961, filed on Mar. 4, 2024.
(60) Provisional application No. 63/631,039, filed on Apr. 8, 2024.
(60) Provisional application No. 63/685,929, filed on Aug. 22, 2024.

(51) Int. Cl. G02C 7/12; G02B 5/30; G02B 27/00

(52) U.S. Cl. CPC G02C 7/12; G02B 5/3016; G02B 27/0093

(57) ABSTRACT

Systems and methods for enabling higher uniform performance and higher voltage operation for micro-OLED displays, manufacturing a meniscus lens including thermo-forming a functional optical layer and printing a lens element over the formed functional optical layer, using a hybrid process used to form a functionalized lens having a controlled surface profile, modeling the polarization properties of a human eye using a polymer thin film, and improving optical sparce eye-tracking by collecting an optical output signal from each detector through a corresponding optical fiber, and determining a gaze direction of a user's eye based on the electrical signal may be disclosed.

### CROSS REFERENCE TO RELATED APPLICATION

This application claims priority to U.S. Application No. 63/606,765, filed 6 Dec. 2023, U.S. Application 63/560,961, filed 4 Mar. 2024, U.S. Application No. 63/631,039, filed 8 Apr. 2024, and U.S. Application No. 63/685,929, filed 22 Aug. 2024, the disclosures of each of which are incorporated, in their entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is an illustration of an exemplary conventional single gate oxide transistor structure, according to embodiments of this disclosure.

FIG. 2 is an illustration of an exemplary dual gate oxide transistor structure with oxide growth, according to embodiments of this disclosure.

FIG. 3A is an illustration of an exemplary self-aligned dual gate oxide transistor, according to embodiments of this disclosure.

FIG. 3B is an illustration of an exemplary self-aligned dual gate oxide transistor with a thick gate dielectric, according to embodiments of this disclosure.

FIG. 4 is an illustration of an exemplary sub-transistor structure, according to embodiments of this disclosure.

FIG. 5 is a schematic illustration of a hybrid lamination and 3D printing process for forming a functionalized lens having a controlled surface profile according to various embodiments.

FIG. 6 is a flowchart of a hybrid lamination and 3D printing process for forming a functionalized lens according to certain embodiments.

FIG. 7 is an illustration of an exemplary method for forming a polymer thin film to model polarization properties of a user's eye, according to some embodiments.

FIG. 8 is an illustration of an exemplary array of sensors for determining a gaze direction of a user's eye, according to certain embodiments.

FIG. 9 is an illustration of an exemplary optical element fabricated using a circular pattern, according to particular embodiments.

FIG. 10 is an illustration of an exemplary optical element fabricated using differently sized circular patterns, according to some embodiments.

FIG. 11 is an illustration of an exemplary optical element fabricated using off-axis circular patterns of an optical beam to create a diffractive structure sensitive to symmetrical objects within its field of view, according to certain embodiments.

FIG. 12 is an illustration of an exemplary gaze of a user's eye for collecting an optical output signal from a first optical fiber, according to some embodiments.

FIG. 13 is an illustration of an exemplary gaze of a user's eye for collecting an optical output signal from a second optical fiber, according to some embodiments.

FIG. 14 is an illustration of an exemplary gaze of a user's eye for collecting an optical output signal from an optical fiber for illuminating the eye, according to particular embodiments.

FIG. 15 is an illustration of an exemplary optical element fabricated using off-axis circular patterns of an optical beam generated by a volume hologram including total internal reflection (TIR), according to some embodiments.

FIG. 16 is an illustration of an example system that incorporates an eye-tracking subsystem capable of tracking a user's eye(s).

FIG. 17 is a more detailed illustration of various aspects of the eye-tracking subsystem illustrated in FIG. 16.

FIG. 18 is an illustration of an example artificial-reality system according to some embodiments of this disclosure.

FIG. 19 is an illustration of an example artificial-reality system with a handheld device according to some embodiments of this disclosure.

FIG. 20A is an illustration of example user interactions within an artificial-reality system according to some embodiments of this disclosure.

FIG. 20B is an illustration of example user interactions within an artificial-reality system according to some embodiments of this disclosure.

FIG. 21A is an illustration of example user interactions within an artificial-reality system according to some embodiments of this disclosure.

FIG. 21B is an illustration of example user interactions within an artificial-reality system according to some embodiments of this disclosure.

FIG. 22 is an illustration of an example wrist-wearable device of an artificial-reality system according to some embodiments of this disclosure.

FIG. 23 is an illustration of an example wearable artificial-reality system according to some embodiments of this disclosure.

FIG. 24 is an illustration of an example augmented-reality system according to some embodiments of this disclosure.

FIG. 25A is an illustration of an example virtual-reality system according to some embodiments of this disclosure.

FIG. 25B is an illustration of another perspective of the virtual-reality systems shown in FIG. 25A.

FIG. 26 is a block diagram showing system components of example artificial- and virtual-reality systems.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

An organic light-emitting diode (OLED), also known as organic electroluminescent (organic EL) diode, is a light-emitting diode (LED) in which the emissive electroluminescent layer is a film of organic compound that emits light in response to an electric current. This organic layer is situated between two electrodes; typically, at least one of these electrodes is transparent. OLEDs are used to create digital displays in devices such as television screens, computer monitors, and portable systems such as smartphones and handheld game consoles.

A micro-OLED is an OLED on silicon. Not only are the pixels themselves smaller, but the entire “panels” are smaller. This is possible thanks to advancements in manufacturing, including mounting the display-making segments in each pixel directly to a silicon chip, which enables pixels to be much smaller.

Micro-OLED displays feature much smaller pixels, enabling micro-OLED displays to achieve much higher resolutions than traditional OLED displays. For example, 4K resolution can be achieved on chips the size of postage stamps. Until recently, the technology has been used in things like electronic viewfinders in cameras, but the latest versions are larger and even higher resolution, making them perfect for augmented reality (AR) and virtual reality (VR) headsets.

For these reasons, micro-OLED displays may be a significant component and enabling factor for mixed reality (MR), AR, and VR applications. For example, the silicon backplane available with micro-OLED displays may make smaller pitch pixels than may be possible with traditional thin film transistor (TFT) options. Further transistor options may include p-channel metal-oxide semiconductor (pMOS) transistors (e.g., four-transistor-two-capacitor (4T2C)). Additionally, a drive transistor may be a significant component for controlling emission brightness of a pixel. Also, besides uniform performance, the capability to tolerate high voltage may become another significant feature with the introduction of tandem OLED devices that generally require 10V or higher driving voltage. On one hand, uniform performance may benefit from a thinner gate oxide so that the gate electrode can better control channel current. On the other hand, high voltage operation may benefit from a thicker gate oxide to meet reliability criteria. Gate oxide selection for the drive transistor faces a dilemma that both of these options cannot be satisfied simultaneously.

Virtual reality (VR), mixed reality (MR), and augmented reality (AR) eyewear devices or headsets may enable users to experience events, such as interactions with people in a computer-generated simulation of a three-dimensional world or viewing data superimposed on a real-world view. By way of example, superimposing information onto a field of view may be achieved through an optical head-mounted display (OHMD) or by using embedded wireless glasses with a transparent heads-up display (HUD) or augmented reality (AR) overlay. VR/MR/AR eyewear devices and headsets may be used for a variety of purposes. For example, governments may use such devices for military training, medical professionals may use such devices to simulate surgery, and engineers may use such devices as design visualization aids.

Pancake optics may be incorporated into virtual reality, mixed reality, and augmented reality systems and devices in order to provide a lightweight and compact form factor suitable for wearable operation. Notwithstanding recent developments, it would be advantageous to provide a more economical pancake optical configuration. Pancake optics including a meniscus lens may be configured to produce a smaller focal point and fewer aberrations than comparative plano-convex lenses. Meniscus lenses have one convex surface and one opposing concave surface with each surface having its own radius of curvature.

A positive meniscus lens has a larger radius of curvature on the concave side and a smaller radius of curvature on the convex side where the edges of such a lens are typically thicker than the center. A positive (or converging) meniscus lens can decrease the focal length of another lens while retaining angular resolution. For instance, positive meniscus lenses may be used to create a tighter beam focus.

A negative meniscus lens has a shorter radius of curvature on the concave side and a longer radius of curvature on the convex side such that the center of the lens is typically thinner than its edges. When used in combination with another lens, a negative (diverging) meniscus lens may be used to increase the focal length and decrease the numerical aperture (NA) of a lens configuration. Negative meniscus lenses may be useful for beam-expanding applications, which require minimal spherical aberration.

In accordance with various embodiments, a hybrid lamination and 3D printing technology may be used to manufacture meniscus lenses that are thin, lightweight, and have smooth surfaces that advantageously derive from a suite of surface characteristics, including primary profile (P), roughness profile (R), and waviness profile (W), which are related to image quality metrics such as pupil swim and image distortion. Functionalized meniscus lenses may have a large thickness variation and aspect ratio, for example, which may be challenging to manufacture using comparative methods such as injection molding.

As disclosed herein, a method of manufacturing a meniscus lens may include discrete molding and printing operations. Such a composite approach may substantially decrease cycle time and manufacturing costs, where a casting or molding paradigm may be used to form and shape a functional stack and 3D printing may be used subsequently to deposit an overlayer to form a functional lens having tuned optical properties.

An example method includes laying up one or more functional layers over a carrier substrate, bonding and shaping the functional layers to a desired profile, printing a layer over the shaped functional layer(s) and curing the printed layer to form a composite lens, and removing the composite lens from the carrier substrate. A suitable shaping apparatus may include a diamond-turned (DT) glass mold.

The laminated architecture may be configured to introduce one or more optical functionalities, such as polarization, retardation, antireflection, diffraction, etc. In some examples, the lamination architecture may include an adhesive/release layer located between the carrier film and the multilayer optical film. The adhesive/release layer may be configured to have strong adhesion to the carrier film but weak peel adhesion with respect to the multilayer optical film. Following lamination, the adhesive/release layer and the oversized carrier film may be separated from the surface-modified lens. Example carrier films may include poly (methyl methacrylate) (PMMA) or a polyolefin polymer. The adhesive/release layer may include a UV-curable acrylate adhesive, for example.

Pancake lenses may be printed from a UV curable resin where the over-formed optical film may be configured to tune the optical properties of the lens. The composite lens may have a desired degree of spheroidicity and/or cylindricity.

A suitable 3D printing apparatus may include a pixel type printer head where the output droplet size may be precisely controlled. An average droplet size may be on the order of a few micrometers. In an example method, a polymeric meniscus lens may be built up by printing onto a molded lens template. As will be appreciated, molded and over-printed lenses may be thinner and substantially lighter weight than comparable lenses manufactured by molding or casting operations. Moreover, 3D printing may be configured to change the cylindrical optical power of a lens template, i.e., along different axes. Such a meniscus lens may be challenging to manufacturing using casting or molding processes alone.

A pancake lens may demonstrate a controlled refractive index, high transmissivity, and low bulk haze. In some embodiments, a meniscus lens may exhibit a high degree of optical clarity and bulk haze of less than approximately 10%. In particular examples, a meniscus lens may be characterized by a refractive index of from approximately 1.45 to approximately 1.6, e.g., 1.45, 1.5, 1.55, or 1.6, including ranges between any of the foregoing values, a transmissivity within the visible light spectrum of at least approximately 90%, e.g., 90, 92, 95, 97, 98, 99, or 99.5%, including ranges between any of the foregoing values, and less than approximately 10% bulk haze, e.g., 0, 1, 2, 4, 6, or 8% bulk haze, including ranges between any of the foregoing values.

Meniscus lenses may be printed from a UV curable resin and may demonstrate a controlled refractive index, high transmissivity, and low bulk haze. In some embodiments, a printed polymeric meniscus lens may exhibit a high degree of optical clarity and bulk haze of less than approximately 10%. In particular examples, a 3D printed meniscus lens may be characterized by a refractive index of from approximately 1.45 to approximately 1.6, e.g., 1.45, 1.5, 1.55, or 1.6, including ranges between any of the foregoing values, a transmissivity within the visible light spectrum of at least approximately 90%, e.g., 90, 92, 95, 97, 98, 99, or 99.5%, including ranges between any of the foregoing values, and less than approximately 10% bulk haze, e.g., 0, 1, 2, 4, 6, or 8% bulk haze, including ranges between any of the foregoing values.

As used herein, the terms “haze” and “clarity” may refer to an optical phenomenon associated with the transmission of light through a material, and may be attributed, for example, to the refraction of light within the material, e.g., due to secondary phases or porosity and/or the reflection of light from one or more surfaces of the material. As will be appreciated by those skilled in the art, haze may be associated with an amount of light that is subject to wide angle scattering (i.e., at an angle greater than 2.5° from normal) and a corresponding loss of transmissive contrast, whereas clarity may relate to an amount of light that is subject to narrow angle scattering (i.e., at an angle less than 2.5° from normal) and an attendant loss of optical sharpness or “see through quality.”

Modern eye-tracking systems often use relatively high-resolution cameras to track a user's eye. These cameras typically include arrays of optical sensing elements with relatively high pixel counts (e.g., kilopixel or megapixel arrays), which may require relatively high bandwidth backend processing. In addition, eye-tracking systems that employ detection of reflected light may be susceptible to noise resulting from ambient light (e.g., light from a real-world environment, light from an electronic display, light from thermal radiation, etc.). Moreover, the human eye may exhibit polarizing behavior that is not captured by the reflected light. Therefore, an accurate physical model of the human eye is desirable in order to develop precise methods of eye-tracking.

The present disclosure is generally directed to systems and methods for enabling higher uniform performance and higher voltage operation for micro-OLED displays. In some embodiments, the dual gate oxide drive transistors disclosed herein are designed to meet both requirements of uniform performance and high voltage operation. Such dual transistor designs include two separate transistors on a single display. The dual gate drive transistor may keep the thin gate oxide portion between the source and gate for better gate to channel control and performance uniformity, and also can tolerate high voltage drop between the gate and drain. By keeping most of the gate oxide thinner, a smaller drive transistor is possible and thus a smaller pixel is possible, to enable higher resolution and/or smaller panel size. Additionally, to prevent the breakdown of the oxide gate(s) due to high voltage exposure, the gate oxide is kept thicker in the gate-to-drain overlap region. In some examples, the present disclosure is directed generally to lens configurations for next-generation optical devices and optical systems, and more specifically to pancake lens architectures that may be configured to provide enhanced optical performance, including improvements in image quality and user experience. Also disclosed are lamination and 3D printing methods for manufacturing pancake lenses and associated structures. As is explained in greater detail herein, embodiments of the present disclosure include lens configurations suitable for virtual, mixed and/or augmented reality systems and devices. Example structures may be configured in an economical form factor and may include one or more printed meniscus pancake lenses having improved surface quality metrics. In some examples, the presently-disclosed hybrid approach may significantly decrease cycle time and associated costs of manufacture. Moreover, the disclosed hybrid lenses may exhibit structures and properties that are not accessible using casting/molding methods alone. Amongst the acts of molding and printing, one or more additional layers may be incorporated into the lens architecture, including a buffer layer, an adhesion-promoting layer, an antireflective coating, etc. A lamination architecture may include a sized multilayer optical film and an adhesive/release layer that are co-integrated with an oversized carrier film. Through the application of pressure to the carrier film, the multilayer optical film may be shaped over a non-planar surface followed by removal of the carrier film and the adhesive/release layer. A 3D printing process may be used to form a thin lens over the shaped optical film. Example lenses may have an ultra-thin profile and a high aspect ratio and may be characterized as light weight having smooth surfaces and exhibiting a large variation in total thickness. The lenses may be configured as positive meniscus lenses or negative meniscus lenses, for instance, and may be formed directly over a suitably shaped (non-planar) substrate or mold.

In some examples, the present disclosure is generally directed to modeling of the human eye that may include polarizing films to account for a complete polarization model of the eye. For example, vortex retarders may use a liquid crystal polymer (LCP) to model birefringence distribution. Localized patterning techniques using inkjet printing may be used as a method for further refinement of a thickness variation of the LCP to model both localized and non-uniform polarizing behavior. Inkjet printing of the LCP may model other polarization properties such as retardance and diattenuation by using a local concentration of dichroic dye. Additionally, a LCP may simulate scattering and other depolarizing behavior of the eye. In this manner, not only may a LCP be an ideal material for modeling the human eye, but also a LCP is able to be thermoformed to other physical models. Furthermore, modeling a human eye including polarization properties may enable the development of next generation eye tracking technology. In some examples, the present disclosure is generally directed to an eye-tracking system based on an array of micro (e.g., <0.5 mm) volume holograms (e.g., Volume Bragg Gratings (VBG)). In some examples, the array may be exposed in a photosensitive layer, such as a waveguide (WG) made from photopolymer or silver halide material. Each volume hologram may act as at least a single-pixel detector, capable of providing optical signals proportional to the symmetry of objects (e.g., circular objects) visible in its field of view. Upon detection, the volume holograms may generate an optical beam of light (e.g., an illumination beam, a laser, etc.) focused on a corresponding optical fiber.

Features from any of the embodiments described herein may be used in combination with one another in accordance with the general principles described herein. These and other embodiments, features, and advantages will be more fully understood upon reading the following detailed description in conjunction with the accompanying drawings and claims.

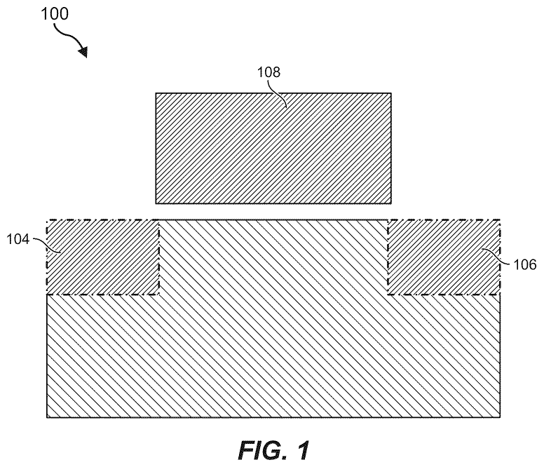

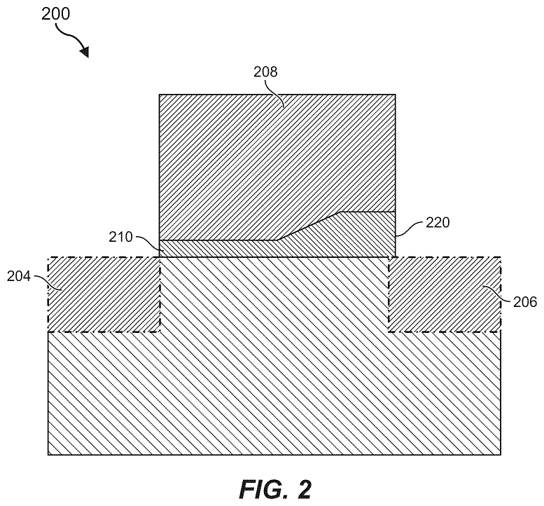

Turning to FIG. 1, a single gate oxide structure 100 may include a source terminal 104, a drain terminal 106, and a gate terminal 108. In some embodiments, FIG. 2 may include a dual gate oxide structure 200. For example, dual gate oxide structure 200 may improve pixel-to-pixel, chip-to-chip, wafer-to-wafer, and lot-to-lot nonuniformity due to process variation. Additionally, dual gate oxide structure 200 may achieve more uniform channel pitch and effective gate length, resulting in more uniform display performance. For example, to achieve uniform electrical and optical performance, the drive transistor is normally much larger than the other pixel transistors in both gate length and gate width. A thinner gate oxide (e.g., thin gate oxide 210) may improve gate to channel control and performance uniformity due to threshold voltage mismatch reduction. With tandem OLED devices being widely adopted, on the other hand, the gate to drain voltage drop also increases, making a thin gate oxide susceptible to breakdown over time. However, keeping most of the gate oxide thin provides better uniformity and makes the gate-to-drain overlap region oxide thicker (e.g., thick gate oxide 220) to tolerate high voltage.

In some embodiments, a method for enabling higher uniform performance and higher voltage operation for micro-OLED displays may include dual transistor structure 200. The dual transistor design may include a source terminal 204, a drain terminal 206, and a gate terminal 208, where gate terminal 208 may be configured to control a flow of current between source terminal 204 and drain terminal 206. The magnitude of the flow of current may be variably adjusted based on a voltage value applied to gate terminal 208. In some embodiments, dual transistor structure 200 may include oxide layers (e.g., thin gate oxide 210 and thick gate oxide 220) that reside proximal to source terminal 204 and drain terminal 206. The oxide layers may include features including but not limited to, adjustable thickness, voltage tolerance, conductive, durability etc. In some methods, the oxide layers may grow across a display (e.g., micro-oled display) with a thickness value that is determined by the voltage applied to gate terminal 208. In further examples, a portion of the oxide layers may be removed via etching (e.g., wet etching) to alter the position of the oxide layers on the display.

A dual gate oxide drive transistor may benefit from accurate critical dimension (CD) control, a thin gate to thick gate alignment control, and process control. Better controls may yield higher grade mask and tools and higher rate of rework, all of which may lead to higher cost and possibly lower performance and yield. An alternative approach may involve using a replacement gate concept (e.g., dummy gate 330) and defining the thick gate dielectric by a film deposition and spacerization process. In this scheme, the portion of the channel covered by the thick gate dielectric 340, as well as thick gate dielectric thickness, may be controlled with the deposition/etch process rather than lithography, with superior process control. Another alternative approach may involve effectively separating a single drive transistor into two sub-transistors (sub transistor structure 400), one with a thin gate oxide 410, and the other with a thick gate oxide 420. In this case, thin gate oxide 410 and thick gate oxide 420 may meet outside the gate area, and errors of CD control, alignment control, or process control may not induce the final transistor performance variation. Additionally, the drive transistor may operate under subthreshold saturation mode to function properly. In this case, the effective channel length may be dependent on the gate voltage, drain voltage, and threshold voltage. Further, the thin and thick gate sub-transistors (e.g., thick gate sub-transistor 450 and thin gate sub-transistor 460) may receive different process conditions, such as channel doping, poly doping, LDD doping, and/or source drain doping according to different requirements. Processing one or more of these alternatives may involve thick gate oxide growth thick gate oxide removal where a thin gate oxide is planned, thin gate oxide growth, gate formation (e.g., polymer deposition and etching), and source and drain formation (e.g., including lightly doped drain-source (LDD)). In some embodiments, the effective channel length is locked by the gate length of thin gate sub-transistor, which operates at a liner mode, while the thick gate sub-transistor, operates under an off mode. Further, the voltage values (e.g., gate voltage, drain voltage, and threshold voltage) of the thin gate sub-transistor and the thick gate transistor may be tuned separately. In some embodiments, a method for enabling higher uniform performance and higher voltage operation for micro-OLED displays may include a self-aligned dual gate transistor design 300. The self-aligned design may include a removable dummy gate 330 (e.g., inactive gate, non-functional gate, replacement gate, etc.) positioned proximal to source terminal 304 and drain terminal 306 that may facilitate oxide growth uniformity. In some methods, the oxide layers may be deposited onto the display via processes including but not limited to, film deposition, dielectric spacerization, etc. The oxide layer (e.g., oxide layer 305) may cover any portion of the transistor, where the dimensions (e.g., thickness, length, etc.) of the deposited oxide layer may be dynamically controlled via the deposition process and/or the etching process.

In some embodiments, a method for enabling higher uniform performance and higher voltage operation for micro-OLED displays may include dividing the dual transistor into sub transistors. The sub transistors may be coupled to one another, where each sub-transistor may have independently controllable oxide layer dimensions. In some methods, the oxide layer dimensions of each sub-transistor may be controlled via lithography processes. In other embodiments, additional transistor configurations to enabling higher uniform performance and higher voltage operation for micro-OLED display may include triple gate and/or multiple gate drive transistors.

Optical configurations including one or more pancake lenses may be used in various applications, such as AR/VR systems, cameras, projection apparatus and other optical systems. Certain applications may require accommodation during operation and hence may incorporate one or more actuators that are configured to change the focal length of the optical configuration. In many cases, the rate of focal length change may be fast, for example, less than 1 second, or even less than 200 ms. Examples may provide one or more of such features where, for example, the response time of the actuators may be on the order of milliseconds or less. In some examples, the change in focal length provided by the actuator may range from 1 diopter to over 5 diopters, and variable cylinder and axis may be provided using appropriate electrical signals provided to the actuator. For example, a controller may determine a desired image distance from the eye of a user (e.g., measured from the front of the cornea or from a display), determine electrical signals to provide a desired focal length of the adjustable lens, and provide the appropriate electrical signals to the actuator to obtain, for example, a curved surface appropriate for the desired image distance.

Compact optical systems may be useful for head-mounted displays, including virtual and augmented reality apparatus. Varifocal operation may be useful for user comfort and experience. A varifocal lens may be an edge-driven lens, where the curvature is, for example, controlled by an actuator located near the edge of the lens, where the actuator may apply a bending force that controls the curvature of the lens. Substantial force may be required for this mode of operation, and the actuator motion may be complicated, possibly increasing space and power requirements and increasing both the actuator and lens weight. Further, adding actuators to the optical configuration may cause stray light issues. However, in some examples, stray light may be reduced by maintaining a high degree of light polarization. In this context, a high degree of light polarization may correspond to a polarization ratio of at least approximately 10:1, such as at least approximately 20:1.

Example optical configurations include at least one lens having variable accommodation. Examples include relatively compact lenses (e.g., compared to lenses having edge-driven actuators), lenses with a wide accommodation range, and lenses with cylinder adjustment. In some examples, an optical configuration including at least one varifocal lens having an optical power that may be adjusted using a controller may provide prescription lens correction for a user (e.g., for real world images) and/or may allow adjustment of the eye accommodation appropriate for a user to view an augmented or virtual image element.

In some examples, an apparatus may include a first lens assembly including a first lens, a reflector, and an actuator layer. The first lens may include a molded and 3D printed meniscus lens. The reflector may include a polarizing reflector, beam splitter or other reflector. An apparatus may further include a second lens assembly including a second lens and a second reflector, such as a polarizing reflector, beam splitter, or other reflector. In some examples, the second lens assembly may include a second lens, a second reflector (e.g., a beam splitter or reflective polarizer). The second lens may include a molded and 3D printed meniscus lens. In some examples, the second lens may include a reflector and an absorbing polarizer. For example, the second reflector may provide an approximately 50/50 (reflected %/transmitted %) beam splitter. However, this ratio is not limiting and the reflected intensity percentage may range from approximately 30% to 70%, with the transmitted percentage correspondingly ranging from approximately 70% to 30%, neglecting absorption losses.

In some examples, a reflector may include a beam splitter. In some examples, a beam splitter may include a thin metal coating, where the metal may include silver, gold, aluminum, other metal (e.g., other transition metal or non-transition metal), or any combination of metals such as an alloy. In some examples, the beamsplitter may include a dielectric layer, a dielectric multilayer, or polymer, such as a polymer layer having a silver appearance. For example, the beam splitter may include a dielectric single or multiple layer, or a combination of any approaches or materials described herein (e.g., a combination of one or more metal layers, dielectric layers, and/or other layers).

In some examples, an apparatus includes a first lens assembly including a first reflective layer and a second lens assembly including a reflective layer and a third layer (e.g., an actuator layer).

For the second lens assembly, the reflective layer may include a reflective polarizer. In some examples, an absorbing polarizer layer may be adjacent and between the reflective layer and the third layer, and the polarization axis of the absorbing polarizer layer may be parallel to the polarization axis of the reflective layer. The reflective layer may be an approximately 50/50 beam splitter. The beam splitter may include a thin metal coating on a substrate, such as a silver layer or aluminum layer on a glass or polymer substrate. The beam splitter may include a single dielectric layer or a multilayer structure such as a dielectric multilayer. In some examples, a beamsplitter may include a combination of one or more metal layers and one or more dielectric layers.

In some examples, the first lens assembly and/or the second lens assembly may each include at least one Fresnel lens. A Fresnel lens may include a 3D printed lens. In some examples, a reflector may include a layer coated on the surface of a Fresnel lens. For example, a reflective polarizer may be supported on a planar or faceted surface of a Fresnel lens.

In some examples, a method of controlling the apparent distance of an image for a user includes determining the desired viewing distance of an image and applying a voltage to a transparent actuator in at least one lens making up the pancake lens to control the curvature of the lens. In some examples, the control of the curvature of the lens may use an open loop system. In some examples, a controller may provide at least one electrical signal to corresponding (at least one) pair of electrodes to independently control a plurality of actuator layers.

In some examples, the control of the curvature of the lens may use a closed loop feedback system where the curvature or a parameter based on the curvature (e.g., optical power) may be determined by a sensor (e.g., a capacitance sensor or an optical sensor such as an image and/or focus sensor). For example, a sensor may determine the curvature of the lens, and the voltage may be controlled or adjusted based on the sensor measurement.

In some examples, a controlled birefringence actuator includes a first actuator layer and at least a second actuator layer, where the first and second actuator layers have a high refractive index axis, and the orientation of the first and second layer are perpendicular to each other. Each actuator layer may be birefringent and have an optic axis parallel to the plane of the layer. For curved actuator layers, the local optic axis may be within the local plane of the layer. An actuator may include (e.g., have only) two actuator layers, where the optic axes of the pair of layers may be orthogonal to each other and may both be within the plane of the respective layer.

In some examples, an actuator may include a stack of 3 or more actuator layers, where the orientation of each layer is clocked. In this context, clocked orientations may refer to actuator layers in which the optic axis (and/or direction of maximum actuation) for each layer may have an angular offset from that of an adjacent or neighboring layer. For example, the optic axes of a plurality of layers may rotate in angular increments around a direction generally orthogonal to the layers. The optic axes may generally describe a stepped spiral around the direction generally orthogonal to the layers. In some examples, an actuator may include at least 5 actuator layers and the orientation of each layer may be clocked.

In some examples, at least one lens assembly may include an active lens, such as a lens assembly including an actuator layer that is transparent and can be electronically energized causing a change in the curvature of the lens. In some examples, the optical configuration may be described as a pancake lens, for example, an imaging lens having first and second partially reflective and partially transparent lens surfaces, where one of the surfaces may be a partial reflector, and the other surface may be a reflective polarizer.

Examples include a lens assembly including an actuator. In some examples, an actuator may include a unimorph and/or a bimorph actuator. A unimorph actuator may include an electroactive layer where applying an electric field to the electroactive layer creates a mechanical force in the plane of the electroactive layer, and a passive layer such as a polymer film, such as an acrylate polymer film such as PMMA (polymethylmethacrylate).

A bimorph actuator may include a first electroactive layer bonded to a second electroactive layer, optionally with a passive layer located between the first and second electroactive layers. In some examples, an actuator may have a multilayer structure and the orientation of the layers may be clocked. In this context, clocked layers may refer to the direction of highest refractive index being rotated in an approximately uniform degree between neighboring actuator layers. For example, a 3 layer stack may have the orientation of the first, second, and third layers oriented (e.g., in plane) at 0°, 60°, and 120°. In some examples, the angular offset (e.g., in-plane angular offset) between successive birefringent layers (e.g., neighboring or adjacent layers, progressing through the stack) may be 360/N degrees, where N is the number of actuator layers in the actuator or a portion thereof.

In some examples, an AR/VR device may include a display and a lens with variable accommodation. The lens may be a pancake lens that folds the light path back on itself to reduce the device dimensions. The device may include a display and a liquid lens having a transparent actuator layer that may be configured to control the optical power of the lens. The device may also include a beamsplitter and a polarized reflector. The actuator layer may include at least one birefringent layer (having different refractive indices in different directions, e.g., different directions within the plane of the layer) and this may cause unwanted optical effects if the display emits polarized light. In some approaches, these effects may be avoided using a display that emits unpolarized light and polarizing the light after it passes through the actuator layer.

In some approaches, linearly polarized light from a display may be aligned with an optical axis of the actuator layer and an optical retarder may be used to compensate for any unwanted optical effects. In further approaches, multiple actuator layers may be stacked and arranged so that the exit light has the same polarization as the input light. For example, birefringent layers may have a clocked multilayer arrangement in which the optic axis rotates around 360 degrees through a plurality of stepped changes in direction, where the angular step between neighboring layers may be at least 10 degrees and may be (at least approximately) equal steps. In some examples, actuators may include polymers with low birefringence that may greatly reduce unwanted optical effects. In some examples, devices may also include an optically absorbing layer to reduce reflections from the user's eye entering the optical system. For example, a lens assembly (e.g., a lens assembly closer to the user's eye) may include an absorbing polarizer.

In some examples, a method may include emitting light (e.g., including one or more light rays) from a display, transmitting the light through a first lens assembly, reflecting the light from a second lens assembly, and reflecting the light from the first lens assembly through the second lens assembly and towards an eye box, for example, where a user may view an image of the display when the user wears the device. One or both lens assemblies may include a Fresnel lens. One or both lens assemblies may include an adjustable lens. One or both assemblies may include a molded and 3D printed meniscus lens. The eye of a user may be located at the eye box (e.g., a location of display image formation) for viewing the image of the display. The first lens assembly may include a first lens and a first reflective polarizer. The second lens assembly may include a second lens and a second reflective polarizer. In some examples, a method may further include adjusting at least one optical parameter (e.g., optical power and/or cylindricity) of at least one lens assembly.

In some examples, an optical retarder may be located between the first and second lens assemblies, and the light from the display may pass through the optical retarder on a plurality of occasions (e.g., three times) before being transmitted through the second lens assembly towards the eye of the user. In some examples, light may be emitted from the display with a polarization, such as a linear polarization or a circular polarization. The polarization may be modified by the optical retarder each time the light passes through the optical retarder.

Reflections may also modify the polarization of light. For example, light (e.g., polarized light) from the display may be transmitted through the first lens assembly, pass through the optical retarder, be reflected by the second lens assembly, pass through the optical retarder, be reflected by the first lens assembly, pass through the optical retarder, and then be transmitted by the second lens assembly towards the eye of a user, where the light may be incident on the reflective polarizer with a first linear polarization, which may be reflected by the reflective polarizer of the second lens assembly. Light may reflect from the reflective polarizer of the first lens assembly and may then be transmitted by the reflective polarizer. In some examples, at least one of the lens assemblies may include an optical retarder and the separate optical retarder may be omitted from the optical configuration. In some examples, a method may further include adjusting at least one optical parameter (e.g., optical power and/or cylindricity) of at least one lens assembly.

In some examples, the image brightness provided by the display (e.g., including a display panel) using an optical configuration may include spatially adjusting the spatial profile of the illumination brightness of a light source (e.g., a backlight) and/or an emissive display. Display brightness may be adjusted as a function of one or more display parameters, such as spatial position on the display (e.g., spatial variations in image brightness), power consumption, aging effects, eye response functions, and/or other parameter(s).

In some examples, a method may include emitting light having circular or linear polarization from a display, transmitting the light through a first lens assembly, reflecting the light from a second lens assembly, and reflecting the light from the first lens assembly through the second lens assembly and towards an eye of a user. The apparatus may be configured so that the light is transmitted through the first lens assembly having a first polarization and reflected by the first lens assembly having a second polarization. This may be achieved using an optical retarder located between the first and second lens assemblies and/or using changes in polarization upon reflection. A display may inherently emit polarized light or, in some examples, a suitable polarizer may be associated with (e.g., attached to) a surface through which light from the display is transmitted. In some examples, a method may further include adjusting at least one optical parameter (e.g., optical power and/or cylindricity) of at least one lens assembly.

Example methods include computer-implemented methods for operating an apparatus, such as an apparatus as described herein such as a head-mounted display or an apparatus for fabricating a lens assembly. The steps of an example method may be performed by any suitable computer-executable code and/or computing system, including an apparatus such as an augmented reality, mixed reality and/or virtual reality system. In some examples, one or more of the steps of an example method may represent an algorithm whose structure includes and/or may be represented by multiple sub-steps. In some examples, a method for providing uniform image brightness from a display using a folded optic configuration may include using a display panel that is configured to allow a spatial variation of the display brightness. In this context, light from a display may be reflected at least once (e.g., twice) within a folded optic configuration before reaching the eye of a user. In some examples, a method may further include adjusting at least one optical parameter (e.g., optical power and/or cylindricity) of at least one lens assembly.

In some examples, an apparatus, such as a head-mounted device or system, may include at least one physical processor and physical memory including computer-executable instructions that, when executed by the physical processor, cause the physical processor to generate an image on the display. The image may include a virtual reality image element and/or an augmented reality image element. The apparatus may include an optical configuration such as described herein. A controller may include the at least one physical processor. The controller may be configured to adjust at least one optical parameter (e.g., optical power and/or cylindricity) of at least one lens assembly. A head-mounted device may be an augmented reality device, a mixed reality device, a virtual reality device, or other device.

In some examples, a non-transitory computer-readable medium may include one or more computer-executable instructions that, when executed by at least one processor of an apparatus (e.g., a head-mounted device), cause the apparatus to provide an augmented reality image or a virtual reality image to the user (e.g., the wearer of the head-mounted device). The apparatus may include an optical configuration such as described herein. A controller may include the at least one physical processor. The controller may be configured to adjust at least one optical parameter (e.g., optical power and/or cylindricity) of at least one lens assembly, for example, by adjusting at least one electrical signal applied to a multilayer actuator through which light used to provide an augmented reality image element passes.

In some examples, an apparatus (e.g., a head-mounted device such as an AR and/or VR device) may include an optical configuration including a pancake lens (e.g., a combination of a lens and a beamsplitter, which may also be termed a beamsplitter lens) and a reflective polarizer. The pancake lens may include a molded and 3D printed meniscus lens.

The optical configuration may be termed a folded optic configuration, and in this context, a folded optic configuration may provide a light path that includes one or more reflections and/or other beam redirections. An apparatus having a folded optic configuration may be compact, have a wide field-of-view (FOV), and allow formation of high-resolution images. Higher lens system efficiency may be useful for applications such as head-mounted displays (HMDs), including virtual reality, mixed reality and/or augmented reality applications.

An example apparatus may include a display, a pancake lens (e.g., including a beamsplitter or polarized reflector that may be formed as a coating on a lens surface), and a reflective polarizer (e.g., configured to reflect a first polarization of light and transmit a second polarization of light, where the first polarization and second polarization are different). For example, a reflective polarizer may be configured to reflect one handedness of circularly polarized light and transmit the other handedness of circularly polarized light.

An example apparatus, such as a head-mounted device, may include a lens assembly including a lens and a reflective polarizer. An example lens may include a molded and 3D printed meniscus lens. An example reflective polarizer may be configured to reflect one polarization of light and transmit another polarization of light. For example, an example reflective polarizer may reflect one handedness of circularly polarized light and may transmit the other handedness of circularly polarized light. A further example reflective polarizer may reflect one linear polarization direction and transmit an orthogonal linear polarization direction. An example apparatus may include a display, and the display may be configured to emit polarized light. In some examples, an apparatus may be an augmented reality and/or virtual reality (AR/VR) headset.

In some examples, an apparatus may include a display and an optical configuration. The optical configuration may include a first lens assembly and a second lens assembly. The first lens assembly may include a lens, such as a fluid lens (e.g., a liquid lens) and/or a Fresnel lens. The lens within the first lens assembly may be a molded and 3D printed meniscus lens. The first lens assembly may include a reflective polarizer or a beamsplitter. An example reflective polarizer may be configured to reflect a first polarization and transmit a second polarization of incident light. The optical configuration mayform an image of the displayviewable by a user when the user wears the apparatus, and the image may provide an augmented reality image to the user.

Folded optic configurations (e.g., including one or more reflective elements such as beamsplitters and/or reflective polarizers) may be compact, have a wide field-of-view (FOV), and provide higher resolution for a given distance between the display and a viewer. Additionally, it may be valuable to adjust an eye focus distance (e.g., a visual accommodation) to an augmented reality image element to obtain a desired visual accommodation in the eye of the user. In some examples, the visual accommodation for a viewed image may be adjusted to at least approximately match an image distance corresponding to the user eye vergence used to view the provided left and right eye images. In this context, vergence may relate to an apparent distance to an image based on convergence of the viewing directions of left and right eyes, and visual accommodation (or, more concisely, accommodation) may refer to an apparent distance to the image based on the focal length of the eye. Visual accommodation may be adjusted by adjusting the optical power of at least one lens.

In some examples, the optical configuration may also provide a prescription lens adjustment of a real world image, for example, including corrections for optical power, cylinder and/or astigmatism. In some examples, a lens assembly may include a lens, such as a Fresnel lens, fluid lens or other refractive lens, and a beamsplitter and/or polarizing reflector.

In some examples, an apparatus component such as a lens or other optical element may include one or more optical materials. An example optical material may be selected to provide low birefringence (e.g., less than one quarter wavelength optical retardance, such as less than approximately lambda/10, for example, less than approximately lambda/20). In some examples, a Fresnel lens and/or filler polymer (and/or other optical element) may include a silicone polymer such as polydimethylsiloxane (PDMS), cyclic olefin polymer (COP), cyclic olefin copolymer (COC), polyacrylate, polyurethane, polycarbonate, or other polymer. For example, a silicone polymer (e.g., PDMS) lens may be supported on a rigid substrate such as glass or a polymer (e.g., a relatively rigid polymer compared with the silicone polymer). In some examples, the optical power of a silicone polymer lens having at least one curved surface may be adjusted using an actuator, such as a multilayer actuator.

In some examples, a component of an optical configuration may include one or more optical materials. For example, an optical material may include glass or an optical plastic. An optical material may be generally transmissive over some or all of the visible spectrum. In some examples, an optical component including a generally transmissive material may have an optical transmissivity of greater than 0.9 over some or all of the visible spectrum and may be termed optically transparent.

In some examples, a substrate (e.g., for a reflector), an optical material, and/or a layer (e.g., of an optical component) may include one or more of the following: an oxide (e.g., silica, alumina, titania, other metal oxide such as a transition metal oxide, or other non-metal oxide), a semiconductor (e.g., an intrinsic or doped semiconductor such as silicon (e.g., amorphous or crystalline silicon), carbon, germanium, a pnictide semiconductor, a chalcogenide semiconductor, or the like), a nitride (e.g., silicon nitride, boron nitride, or other nitride including nitride semiconductors), a carbide (e.g., silicon carbide), an oxynitride (e.g., silicon oxynitride), a polymer (e.g., a UV curable polymer), a glass (e.g., a silicate glass such as a borosilicate glass, a fluoride glass, or other glass), or other material.

Example reflective polarizers may include, without limitation, cholesteric reflective polarizers (CLCs) and/or multilayer birefringent reflective polarizers. A reflective polarizer may include a wire grid, a multilayer birefringent polymer, or a cholesteric reflective polarizer. In this context, a cholesteric reflective polarizer may have optical properties similar to (and in some examples, derived from) a cholesteric liquid crystal. A cholesteric reflective polymer may include a solid (e.g., have at least one solid component), such as a polymer (e.g., a cross-linked polymer), a polymer stabilized material or a polymer-dispersed material.

In some examples, a reflective polarizer may be fabricated by applying an alignment layer (e.g., a polymer layer or grating) and applying at least one layer of a cholesteric liquid crystal (CLC) which is at least partially aligned to the alignment layer. The alignment layer may include a photoalignment material (PAM) that may be deposited over a substrate, and a desired molecular orientation may be obtained by exposing the PAM to polarized light (such as ultraviolet (UV) and/or visible light). A CLC may be further processed to lock the molecular alignment of a CLC within a solid material, for example, to provide a chiral material such as a chiral solid. A CLC may be polymerized, cross-linked, and or a polymer network may be formed through the CLC to stabilize the alignment to provide a chiral solid. A chiral solid may be referred to as a CLC-based material if a CLC phase was used in its preparation. In some examples, a CLC may be formed using an effective concentration of chiral dopant within a nematic liquid crystal, and the chiral nematic (cholesteric) mixture may further include polymerizable materials.

In some examples, a reflective polarizer may include a chiral material such as a material having molecular ordering similar to that of a cholesteric liquid crystal, such as a solid material derived from cooling, polymerizing, cross-linking, or otherwise stabilizing the molecular order of a cholesteric liquid crystal. For example, a chiral solid may be a solid having a helical optical structure similar to that of a cholesteric liquid crystal. For example, a direction of maximum refractive index may describe a helix around a normal to the local direction of molecular orientation.

Examples may include an apparatus having a folded optic configuration, such as an apparatus including one or more lenses, such as a pair of lens assemblies. Example optical configurations may allow an increased optical efficiency of an optical configuration, for example, by reducing losses associated with beamsplitters. Increased optical efficiency may provide one or more of the following aspects: improved image appearance (e.g., improved image brightness, uniformity and/or resolution), increased lens efficiency, reduced power consumption, and/or reduced heat generation for a given brightness. Examples also include associated methods, such as methods of fabrication of improved lens assemblies, methods of fabricating devices including one or more actuators and/or lens assemblies, or methods of device use.

In some examples, a reflective polarizer may include a birefringent multilayer optical film that may be conformed to a surface (e.g., the faceted substrate of a Fresnel lens or a membrane surface of an adjustable fluid lens) through a combination of heat and pressure.

In some examples, the reflective polarizer may include a cholesteric liquid crystal, a birefringent multilayer optical film, or a wire grid. In some examples, a reflective polarizer may include an arrangement of electrically conductive elements, such as wires, rods, tubes, or other conductive elements. Electrically conductive elements may include at least one metal (e.g., copper, gold, silver, or other metal or alloy thereof), electrically conductive carbon allotrope, doped semiconductor, or the like. In some examples, a reflective polarizer may include a birefringent multilayer film, and the skin layer or layers may have a pass polarization refractive index that is within approximately 0.2 of the average refractive index of the multilayer film, and in some examples, a refractive index that differs from the average refractive index of the multilayer film by at least approximately 0.02, such as at least approximately 0.05, for example, at least approximately 0.1.

In some examples, a reflective polarizer may include a multilayer assembly including at least one optically isotropic layer adjacent to (e.g., alternating with) a birefringent (e.g., uniaxial) polymer layer. Layers may be generally parallel and may conform to an underlying optical element that may act as a substrate. An optically isotropic polymer layer may include an optically transparent polymer. A birefringent polymer layer may include an anisotropic polymer layer, such as a stretched or otherwise at least partially molecularly aligned polymer layer. For example, a polymer layer may be stretched by a factor of between 1.5 and 10 (e.g., stretched by a ratio of between 1.5:1 and 10:1, where the ratio represents a ratio of a final extent along a particular direction to an initial extent).

An example reflective polarizer may be configured to reflect a first polarization of light and transmit a second polarization of light. For example, a reflective polarizer may be configured to reflect one handedness of circularly polarized light (e.g., right or left) and transmit the other handedness of circularly polarized light (e.g., left or right, respectively). In further examples, a reflective polarizer may be configured to reflect one direction of linearly polarized light (e.g., vertical) and transmit an orthogonal direction of linearly polarized light (e.g., horizontal). In some examples, the reflective polarizer may be adhered to a lens surface, such as the facets of a Fresnel lens or the curved outer surface of a meniscus lens.

In some examples, a reflective polarizer may include a cholesteric liquid crystal, such as a polymer cholesteric liquid crystal, or a solid layer having the optical properties of a cholesteric liquid crystal (e.g., a crosslinked or network stabilized CLC). In some examples, a reflective polarizer may include a birefringent multilayer reflective polarizer. In some examples, an apparatus may further include an optical retarder, such as a quarter wave retarder, located between the beamsplitter and the reflective polarizer.

Example reflective polarizers (or other polarizers) may include polarizing films. An example polarizing film may include one or more layers, such as an optical polarizer including a combination of a reflective polarizer and a dichroic polarizer, for example, bonded together.

In some examples, a polarizing beam splitter may include a transparent lens with a first and a second surface, where the first surface may be an adjustable lens (e.g., a fluid lens, a Fresnel lens, or other lens) and the second surface is adjacent to a reflective polarizing layer. At least one of the first and second surfaces may have a cylindrical, spherical, or aspherical curvature that may be controlled using an actuator.

In some examples, a reflector may include a reflective polarizer and/or a beamsplitter (e.g., a partial reflector). A partial reflector may include a coating that is partially reflective and partially transparent to at least one operational wavelength. In some examples, a reflector may change the handedness of reflected circularly polarized light. The reflector may include at least one thin uniform metallic coating, such as at least one of a thin silver or aluminum coating, a patterned metallic coating, a dielectric coating, other coating, or any combination thereof.

In some examples, a polarizer layer may include an arrangement of microparticles and/or nanoparticles in an optical material, such as a polymer matrix. Example optical materials may include one or more fluoropolymers (e.g., polymers of one or more monomer species such as tetrafluoroethylene, vinylidene fluoride, chlorotrifluoroethylene, perfluoroalkoxy compounds, fluorinated ethylene-propylene, ethylenetetrafluoroethylene, ethylenechlorotrifluoroethylene, perfluoropolyether, perfluoropolyoxethane, and/or hexafluoropropylene oxide).

Example polymers may include organosilicon compounds such as silicone polymers, including polymers of siloxane or silyl derivatives such as silyl halides. Polymers may also include polymers of one or more monomer species such as ethylene oxide, propylene oxide, carboxylic acid, acrylates such as acrylamide, amines, ethers, sulfonates, acrylic acid, vinyl alcohol, vinylpyridine, vinylpyrrolidone, acetylene, heterocyclic compounds such as pyrrole, thiophene, aniline, phenylene sulfide, imidazole, or other monomer species.

Particles may include one or more materials such as metals (e.g., transition metals, aluminum, alloys), metal oxides (e.g., transition metal oxides, magnesium oxide, aluminum oxide, zinc oxide, zirconium oxide, or transparent conductive oxides such as indium tin oxide, indium gallium zinc oxide, or antimony tin oxide), carbides, nitrides, borides, halides, fluoropolymers, carbonates (e.g., calcium carbonate), carbon allotropes (e.g., fullerenes or carbon nanotubes), and mixtures thereof. Examples also include glass particles, ceramic particles, silicates, or silica. Particles may include one or more polymers, including polymers described herein, such as poly(tetrafluoroethylene) particles. As used herein, particles may include microparticles, nanoparticles, spherical particles, rods, tubes, or other geometric or non-geometric shapes.

In some embodiments, an apparatus may include an optical configuration that includes a Fresnel lens assembly. A Fresnel lens assembly may include a reflective polarizer configured to reflect a first polarization of light and transmit a second polarization of light. For example, a reflective polarizer may reflect one handedness of circularly polarized light and transmit the other handedness of circularly polarized light. Example apparatus may include a beamsplitter lens or, in some examples, a second Fresnel lens assembly. A beamsplitter lens may include a beamsplitter formed as a coating on a lens.

Fresnel lens assemblies including a reflective polarizer may be used in augmented reality and/or virtual reality (AR/VR) systems. In some examples, a Fresnel lens assembly may include a Fresnel lens and at least one other optical component, such as one or more of a reflective polarizer, an optical filter, an absorbing polarizer, a diffractive element, an additional refractive element, a reflector, an antireflection film, a mechanically protective film (e.g., a scratch-resistant film), or other optical component. An apparatus including a Fresnel lens assembly may further include a display and a beamsplitter.

In some examples, an AR/VR system may include a Fresnel lens assembly including a Fresnel lens and a polarized reflector. The optical properties of the Fresnel lens may be determined individually, but in some examples, the properties of a reflective polarizer, filler layer, or other layer may be configured to improve the Fresnel lens performance (e.g., by reducing chromatic aberration). In some examples, a Fresnel lens may be concave, convex, or may have a complex optical profile such as a freeform surface. For example, the structured surface of a Fresnel lens may include facets corresponding to portions of a freeform lens optical surface, or of other lens surfaces such as other concave or convex surfaces. In particular embodiments, a Fresnel lens may be formed by molding and 3D printing.

The wavelength-dependent properties of a Fresnel lens assembly, or polarized reflector, may be adjusted by, for example, controlling one or more parameters of a multilayer film configuration (e.g., individual layer refractive indices, optical dispersion, and/or layer thicknesses). In some examples, a reflective polarizer may have a particular bandwidth of operation and the bandwidth of operation may be adjusted using one or more parameters of one or more components (e.g., refractive index, optical dispersion, layer thickness, and the like).

Applications of Fresnel lens assemblies may include use in the optical configuration of a wearable device (e.g., a head-mounted device), for example, use of one or more Fresnel lens assemblies in an optical configuration adapted to form an image of a display viewable by a user when the user wears the wearable device. Other example applications may include IR (infra-red) rejection in, for example, imaging, display, projection, or photovoltaic systems. Applications may include wavelength selection for optical waveguides, for example, to select red, green, yellow, and/or blue wavelengths for transmission along a waveguide using a Fresnel lens assembly at the waveguide input. In some examples, a structured surface may be formed at the light entrance to any suitable optical component and configured as a Fresnel lens assembly.

A Fresnel lens assembly may include a Fresnel lens and a polarizer. For example, at least one facet of a Fresnel lens may support a reflective polarizer or absorptive polarizer. A Fresnel lens may include a plurality of facets and steps formed in an otherwise planar surface, a cylindrical surface, a freeform surface, a surface defined at least in part by a Zernike function, or a spherical surface. A Fresnel lens, including its facets and steps, may be formed by molding and 3D printing. A Fresnel lens assembly may include additional components, such as a substrate, filler polymer layer, or any suitable optical element.

In some examples, a Fresnel lens assembly may include a Fresnel lens and a reflective polarizer. In some examples, the reflective polarizer may be supported by (e.g., deposited on, adhered to, or otherwise supported by) the facets of the Fresnel lens.

In some examples, a Fresnel lens assembly including a reflective polarizer may further include a filler layer. The filler layer may include an optically clear layer that is located on the structured surface of the Fresnel lens assembly. For example, a filler layer may conform to the facets and steps of a structured surface (e.g., of a Fresnel lens) and may have a second surface without facets or steps, for example, a generally smooth surface. For example, the filler layer may have a planar, concave or convex surface that may also be an exterior surface or support one or more additional layers, such as an antireflection layer or other optical layer. A reflective polarizer may be formed on a facet of a structured optical element, such as a Fresnel lens. In some examples, a reflective polarizer may include a multilayer reflective polarizer including at least one birefringent layer. In some examples, a reflective polarizer may include one or more polymer layers and/or one or more inorganic layers.

In some examples, a structured optical element may include a substrate having a surface including facets and steps, where the steps are located between neighboring (e.g., proximate or substantially adjacent) facets. A reflective polarizer may be located adjacent to and conforming to at least a portion of a faceted surface. In some examples, a faceted surface may correspond to a surface portion of a refractive lens, such as a convex or concave surface, and may be curved. In some examples, a facet may be planar and may approximate a surface portion of a refractive lens. For example, a planar faceted surface may have an orientation to the optic axis of the lens that varies with the average (e.g., mean) radial distance of the facet from the optical center of the lens. In this context, a structured optical element may include surface facets separated by steps, and at least one facet of a Fresnel lens may support a reflective polarizer. The filler material may then coat a surface of a Fresnel lens assembly (e.g., including facets, steps and the reflective polarizer). The filler layer may have a first surface having a profile that is complementary to the Fresnel lens assembly, and a second surface (e.g., an exterior surface) that may be a planar surface. In some examples, the second surface of the filler material may have a curved surface, such as a convex, concave, cylindrical, freeform, or other curved surface, or, in some examples, may include a second Fresnel lens structure.

In some examples, the steps between facets may have step heights and/or draft angles that may be a function of position within the optical element, for example, a function of radial distance from the optical center of a lens. In some examples, the gap between adjacent reflective polarizer segments may vary as a function of position within the optical element, such as a function of radial distance from the optical center of the lens. In some examples, a Fresnel lens assembly includes at least one Fresnel lens and is configured to reflect a first polarization of light and transmit a second polarization of light. The Fresnel lens assembly may include a reflective polarizing layer disposed on the facets of the structured surface of a Fresnel lens.

In some examples, a structured optical element (e.g., a Fresnel lens) may include a substrate having at least two adjacent facets that are separated by a step (sometimes referred to as a riser), where the facets have facet surfaces, and where a reflective polarizer layer is adjacent to and conforms to at least a portion of the facet surface of at least one of the facets.

In some examples, a lens may include an optical layer (e.g., a reflective polarizer, an absorbing polarizer, an optical retarder, an optical absorber or other optical layer) formed as a coating on a lens surface, such as one or more Fresnel lens facets. An optical layer may include a multilayer optical layer, a cholesteric liquid crystal or solid derived therefrom or having similar optical properties, or an anisotropic layer or a layer including anisotropic electrical conductors.

In some examples, a Fresnel lens may include a reflective polarizer formed as a layer on one or more of the lens facets. The reflective polarizer may include a multilayer optical film, cholesteric liquid crystal, or an arrangement of anisotropic conductors. The facets and coating may be embedded in an optically clear layer, such as a filler polymer. The refractive indices and optical dispersions of the Fresnel lens material and the filler polymer may be selected to reduce chromatic aberration (e.g., colored fringes in the image).

In some examples, optical materials (e.g., used in a Fresnel lens) may have a low birefringence (e.g., corresponding to less than a quarter wavelength optical retardance). In some examples, a Fresnel lens and/or filler polymer may include a silicone polymer such as polydimethylsiloxane (PDMS), cyclic olefin polymer (COP), cyclic olefin copolymer (COC), polyacrylate, polyurethane, or polycarbonate. For example, a PDMS Fresnel lens may be supported on a rigid substrate such as glass.

Vapor deposition of coatings may lead to unwanted deposition on the risers between facets. Appropriately sectioned coating layers may be selectively located on the facets of a Fresnel lens using an elastomeric substrate. Fresnel lens supported reflective polarizers may be used in augmented reality and/or virtual reality (AR/VR) systems. Other components may include a display and a beamsplitter. In some examples, an AR/VR system may include a Fresnel lens supported beamsplitter, and lenses may be optimized separately. Fresnel lenses may be concave, convex, or may have complex optical profiles such as freeform surfaces. Wavelength-dependent properties may be adjusted by, for example, adjusting multilayer film configurations.

In some examples, a Fresnel lens may include a flexible and/or elastic material (e.g., a silicone polymer such as PDMS) and may be formed on an actuator, such as a multilayer actuator. In some examples, an actuator may be located between a relatively rigid substrate (e.g., glass or an acrylate polymer) and an elastomer-based Fresnel lens structure. Electrical signals applied to the actuator may be used to control the slope of the facets of the Fresnel lens and hence the optical power of the Fresnel lens.

In some examples, the facets of a Fresnel lens and an optional optical layer formed thereon may be embedded in a filler layer such as an optically transparent filler polymer layer. For example, a filler layer may be formed supported by an assembly including the Fresnel lens and the polarizer. The filler layer may include an optically transparent polymer. The filler layer may have a structured surface complementary to the Fresnel lens and any other coating disposed thereon, and a second surface that may be generally smooth (e.g., planar, concave, or convex) or, in some examples, may be faceted to provide additional optical power (e.g., using a second Fresnel lens formed in the filler layer).

The refractive indices and optical dispersions of the Fresnel lens material and the filler polymer may be selected to reduce chromatic aberration (e.g., colored fringes in the image). Preferably, optical materials have low birefringence (e.g., less than one quarter wavelength optical retardance for at least one visible wavelength). An example Fresnel lens and/or optional filler polymer may include a silicone polymer such as polydimethylsiloxane (PDMS), cyclic olefin polymer (COP), cyclic olefin copolymer (COC), polyacrylate, polyurethane, or polycarbonate. For example, a PDMS Fresnel lens may be supported on a rigid substrate such as glass.

In some examples, a lens may have a polarizer, such as a reflective polarizer or absorptive polarizer, formed as a layer on at least one of the lens surfaces. The layer may include a multilayer optical film, cholesteric liquid crystal, or an arrangement of anisotropic conductors such as a nanowire arrangement. In some examples, the lens may be a Fresnel lens and the facets and any layer(s) may be embedded in a filler layer that may include an optically clear polymer. In some examples, a filler layer may planarize or otherwise smooth an exterior surface of a Fresnel lens assembly. The refractive indices and optical dispersions of the lens material and any additional layers may be configured to reduce chromatic aberration (e.g., to reduce visually discernable colored fringes in an image of the display). In some examples, the filler polymer may be configured as a second Fresnel lens, a geometric lens, and/or diffractive lens. For example, the filler polymer may have a first surface having facets forming an interface with the first Fresnel lens, and a second surface such as a non-faceted surface (e.g., a planar surface or a curved surface such as a concave, convex, aspheric or freeform surface) or a faceted surface. In some examples, the filler polymer may form a diffractive lens including diffractive elements on one or both surfaces. In some examples, a reflector or reflective polarizer may be located between the facets of the first Fresnel lens and the filler polymer.

Appropriately sectioned coating layers (e.g., at least partially reflective layers such as reflectors, beamsplitters, or reflective polarizers) may be selectively located on the facets of an optical element (e.g., a lens such as a Fresnel lens) using any suitable approach, for example, using an elastomeric substrate or other substrate to urge the coating layer against a surface of the optical element. Lens (e.g., Fresnel lens) supported reflective polarizers may be used in augmented reality and/or virtual reality (AR/VR) systems. Additional components may include a display and a beamsplitter.

In some examples, the reflective polarizer may be patterned to be in registration with the facets of the Fresnel lens. The patterned reflective polarizer may be formed on an elastomer element, aligned with the facets, and then the elastomer element may be moved (e.g., by an actuator) so that the patterned reflective polarizer is urged in contact with the facets of the Fresnel lens.

In some examples, an AR/VR system may include a Fresnel lens supported beamsplitter, and individual lenses may be designed separately. Fresnel lenses may be concave, convex, or may have complex optical profiles such as freeform surfaces. Wavelength-dependent properties may be adjusted by, for example, adjusting multilayer film configurations.

In some examples, an optical configuration may be used to introduce a phase delay into one or more polarization components of a light ray. Examples include quarter wave plates and half wave plates. In some examples, an optical retarder may be used to convert circular polarization into a linear polarization or vice versa.

In some examples, a reflective polarizer may include a cholesteric liquid crystal, such as a polymer (cross-linked) cholesteric liquid crystal. In some examples, the reflective polarizer may include a birefringent multilayer reflective polarizer combined with a quarter wave retarder placed between the reflective polarizer and a second reflector (e.g., a beamsplitter or other reflective polarizer).

A beamsplitter may be configured to reflect a first portion of incident light and transmit a second portion of incident light. In some examples, a beamsplitter lens may include a lens (e.g., a Fresnel lens or other lens) and a beamsplitter formed on at least a portion of a lens surface or, for example, at an interface between components of a lens assembly.

In some examples, a beamsplitter may be formed on the surface of a lens, such as on the facets of a Fresnel lens, using one or more of various approaches. For example, a beamsplitter may be formed on an elastic element and urged against the surface of an optical component such as a lens. A beamsplitter may be formed on a substrate and patterned to form portions sized to match the facets of a Fresnel lens.

An example reflective layer may include one or more metals such as aluminum or silver, and may be metallic. An example reflective layer may include one or more dielectric materials such as silica, aluminum oxide, hafnium oxide, titanium dioxide, magnesium oxide, magnesium fluoride, indium tin oxide, indium gallium zinc oxide, and the like, as well as combinations thereof. An example reflective layer may include one or more dielectric layers, and may include a Bragg grating structure or similar multilayer structure.

Reflective layers may be formed by one or a combination of processes including thin film physical vapor deposition, chemical vapor deposition, or other suitable processes for depositing reflective layers, such as highly and/or partially reflective thin film coatings.

An example beamsplitter may include one or more regions having different transmissivity and/or reflectance, and may include one or more reflective layers. An example beamsplitter may include first and second regions having a different reflectance, for example, for visible light or at least one visible wavelength of light. A beamsplitter may include a coating formed on a surface of the lens, such as a metal coating and/or a dielectric coating such as a dielectric multilayer. In some examples, the reflectance of a beamsplitter may vary as a function of spatial position within the beamsplitter. For example, a beamsplitter may include a first region having a first reflectance and a second region having a second reflectance. In some examples, a beamsplitter may have a higher reflectance toward the edges of the beamsplitter than within a central region of the beamsplitter.

An example beamsplitter may include a coating that is partially transparent and partially reflective. An example beamsplitter may include a thin coating including a metal such as gold, aluminum, or silver. A thin coating may have a coating thickness in the range of approximately 10 nm to approximately 500 nm. An example beamsplitter may include one or more layers, such as dielectric thin film layers. In some examples, a beamsplitter may include at least one dielectric material, for example, as a dielectric layer or component thereof, such as silica, aluminum oxide, hafnium oxide, titanium dioxide, magnesium oxide, magnesium fluoride, and the like. An example beamsplitter may include a coating including at least one thin metal coating and/or at least one dielectric coating. An example beamsplitter may include at least one of an electrically conductive material (e.g., a metal, an electrically conductive metal oxide such as indium tin oxide or indium gallium zinc oxide, or other conductive material) and a dielectric material, and may include a combination of an electrically conductive material and a dielectric material (e.g., as a coating including at least one layer).

In some examples, a beamsplitter may be formed on a convex, planar, or concave surface of a lens. The lens may be formed by 3D printing. In some examples, the lens may include a Fresnel lens. In some examples, a polarized reflector may be configured to function as a beamsplitter and may, for example, be configured to reflect a first percentage of a first polarization of light and a second percentage of a second polarization of light, where the first and second percentages may be different, while transmitting some, most, or effectively all of the non-reflected light.

An example reflector (e.g., a beamsplitter, polarized reflector, or other reflector) may include at least a first and a second region, where the first region may include a central region of the reflector, and the second region may include an outer (peripheral) region of the reflector. In some examples, a reflector (e.g., a beamsplitter or a polarized reflector for a particular polarization) may have a reflectance of approximately 100%, approximately 95%, approximately 90%, approximately 85%, approximately 80%, approximately 75%, approximately 70%, or within a range between any two example values of these example reflectance values. The second region may have a reflectance between approximately 75% and approximately 100%, such as a reflectance between approximately 85% and approximately 100%. In some examples, the second region may have a higher reflectance than the first region, such as at least 10% higher reflectance.

In some examples, the relationship between reflectance and distance may be a monotonic smooth curve. In some examples, the relationship between reflectance and distance may be discontinuous or include transition regions with relatively high rates of change in reflectance. In some examples, there may be a gradual transition in reflectance of the beamsplitter from the first region to the second region within a transition region. The transition region may have a width (which may be termed a transition distance) that may be less than approximately 5 mm, such as less than 2 mm, such as less than 1 mm. In some examples, the transition region width may be less than 0.1 mm, such as less than 0.01 mm.

In some examples, a reflector (e.g., a beamsplitter or polarized reflector) may include a layer that is partially transparent and partially reflective. In some examples, a reflector may include a metal film formed on a substrate, such as a substrate including one or more optical materials. For example, the layer may include a metal layer (e.g., having a thickness between approximately 5 nm and approximately 500 nm, such as a thickness between 10 nm and 200 nm), such as a layer including one or more metals such as aluminum, silver, gold, or other metal such as an alloy. The layer may include a multilayer, and may include a corrosion protection layer supported by the exposed surface of the layer. In some examples, the layer may include one or more dielectric layers, such as dielectric thin film layers. Dielectric layers may include one or more dielectric layers such as oxide layers (e.g., metal oxide layers or other oxide layers), nitride layers, boride layers, phosphide layers, halide layers (e.g., metal halide layers such as metal fluoride layers), or other suitable layers. In some examples, the device may include one or more metal layers and/or one or more dielectric layers. A substrate may include glass or an optical polymer and may be rigid or mechanically compliant.

In some examples, an apparatus may include a display, at least one Fresnel lens assembly including a polarized reflector, and optionally a beamsplitter lens including a beamsplitter. The reflectance of the beamsplitter and/or the polarized reflector may vary as a function of spatial position, for example, including a first region of relatively high optical transmission and a second region of relatively low optical transmission (e.g., of relatively higher reflectance). In this context, a segmented reflector may have at least two regions having different optical properties, such as regions of different values of reflectance, for example, for one or more visible wavelengths.

In some examples, a device may include a reflector having a gradual or effectively discontinuous transition in the reflectance from a first region to a second region. A transition region may be located between the first region and the second region. As measured along a particular direction (e.g., a radial direction, normal to the periphery of the first region, or other direction) the transition region may extend over a transition distance between the first region and the second region. In some examples, the transition distance may have a length that is approximately or less than 5 mm, 1 mm, 0.1 mm, or 0.01 mm.

In some examples, a reflector may provide selective reflection over a particular wavelength range and/or for a particular polarization. For example, a reflector may include a Bragg reflector, and layer composition and/or dimensions may be configured to provide a desired bandwidth of operation.

In some examples, a reflector may be formed on an optical substrate such as a lens, and a combination of a lens and a reflector may be termed a reflector lens. A reflector lens may include an optical element having at least one curved surface. A reflector may include a reflective coating formed on or otherwise supported by a planar or a curved surface of an optical element such as a lens.

During fabrication of a reflector, different reflector regions having different values of optical reflectance may be defined by a masked deposition process or using photolithography, or a combination thereof.

In some examples, a lens (such as a Fresnel lens) may include a surface such as a concave surface, a convex surface or a planar surface. In some examples, a device may include one or more converging lenses and/or one or more diverging lenses. An optical configuration may include one or more lenses and may be configured to form an image of at least part of the display at an eye box. A device may be configured so that an eye of a user is located within the eye box when the device is worn by the user. In some examples, a lens may include a Fresnel lens having facets formed on a substrate including an optical material. In some examples, an optical configuration may include one or more reflectors, such as mirrors and/or reflectors.

In some examples, apparatus efficiency may be increased using a pancake lens including a beamsplitter that has higher reflectance toward the edges of the beamsplitter than within a central region of the beamsplitter. Lens efficiency may be increased using a polarization-converting beamsplitter lens including a beamsplitter that has higher reflectivity toward the edges of the lens than within a central region of the lens. In some examples, a pancake lens may include a refractive lens and a beamsplitter that may be formed as a reflective coating on a surface of the lens. The reflective coating may have a spatially varying reflectance. In some examples, a pancake lens may include a polarization-converting beamsplitter lens.

In some embodiments, an apparatus may include a display (e.g., a display panel) and a folded optic lens. Light from the display panel incident on the folded optic lens may be circularly polarized, linearly polarized, elliptically polarized or otherwise polarized. In some examples, the display may be an emissive display or may include a backlight. An emissive display may include a light-emitting diode (LED) array, such as an OLED (organic light-emitting diode) array. In some examples, an LED array may include a microLED array, and the LEDs may have a pitch of approximately or less than 100 micrometers (e.g., approximately or less than 50 micrometers, approximately or less than 20 micrometers, approximately or less than 10 micrometers, approximately or less than 5 micrometers, approximately or less than 2 micrometers, approximately or less than 1 micrometer, or other pitch value).

In some examples, the display may emit polarized light, such as linearly polarized light or circularly polarized light. In some examples, the display may emit linear polarized light and an optical retarder may be used to convert the linear polarization to an orthogonal linear polarization. In some examples, the combination of an optical retarder and a linear reflective polarizer may be replaced with an alternative configuration, such as a circularly polarized reflective polarizer which may include a cholesteric liquid crystal reflective polarizer.

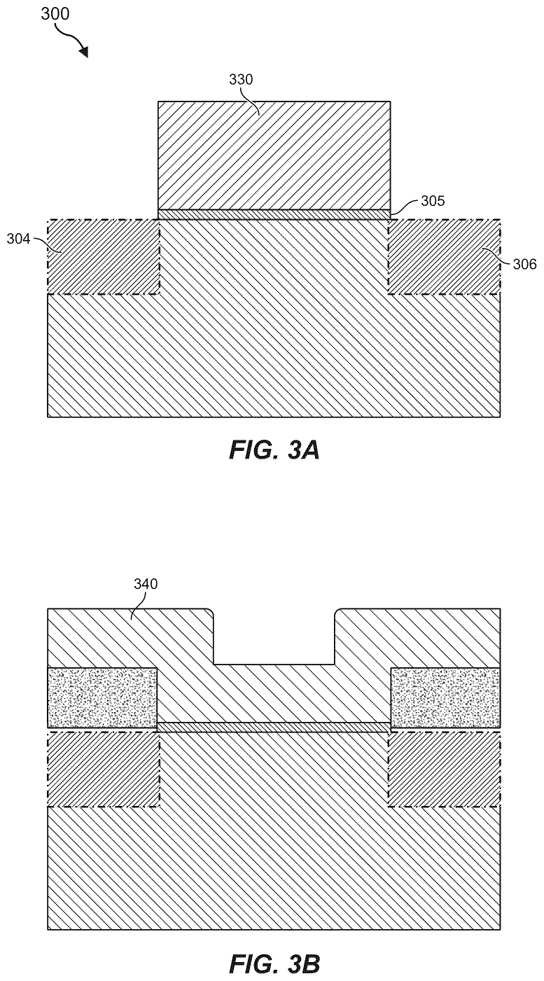

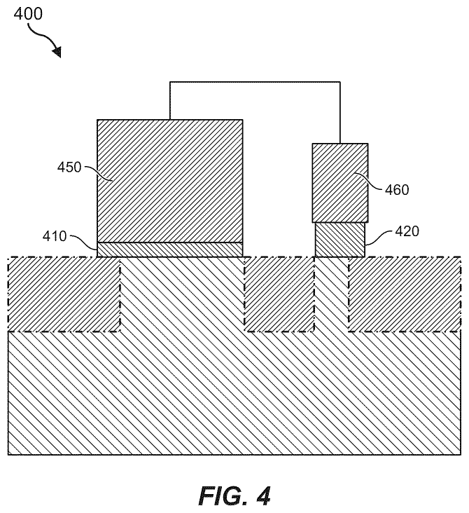

The following will provide, with reference to FIGS. 1-4, detailed descriptions of methods for optical system manufacture and associated pancake lens architectures. The discussion associated with FIGS. 1 and 2 includes a description of a composite process for forming a meniscus lens having a controlled surface profile. The discussion associated with FIGS. 3 and 4 relate to exemplary virtual reality and augmented reality devices that may include one or more laminated and 3D printed pancake lenses as disclosed herein.

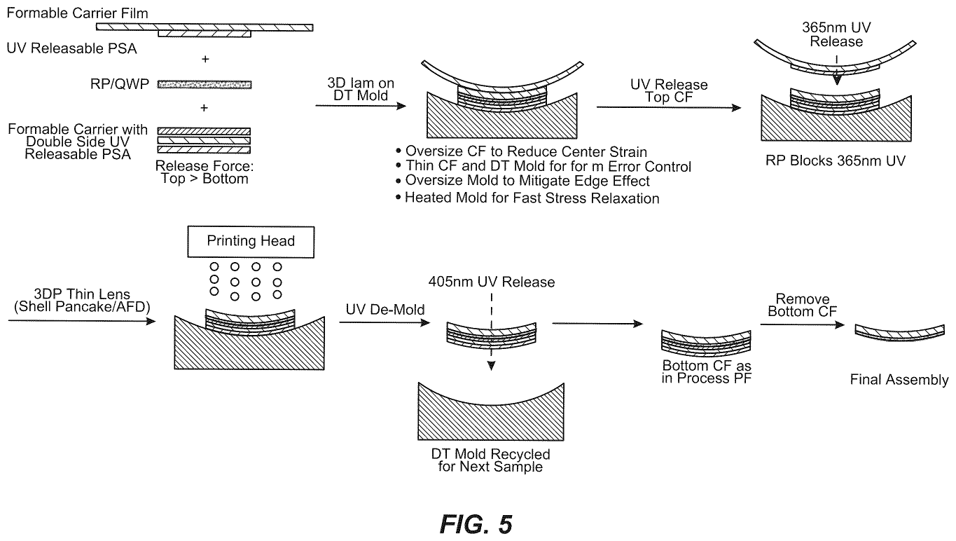

Applicants have shown that lamination and 3D printing may be used to provide lens architectures having improved image quality in a wearable form factor, e.g., having a smaller sized display. Turning to FIG. 5, shown schematically is an example composite 3D forming and 3D printing method for manufacturing a meniscus lens. The method may include sequential acts of molding and 3D printing.

In the illustrated method, one or more functional layers may be laid up and bonded to one or more supporting carriers and then thermoformed to have a desired profile. The stacked layer architecture is shown in FIG. 5. The pre-form may include a reflective polarizer and a quarter waveplate, for example, although further components are contemplated and may be incorporated into the stack. A layer of pressure-sensitive adhesive may be used to secure the functional layers to each of the one or more supporting carriers. In certain instantiations, the pre-forming process may relax residual stresses within the optical film stack, which decreases the risk of deformation of the printed lens.

The choice of carrier layer and adhesive/release layer may influence the mechanical as well as the optical properties of the laminated pancake optic. For instance, a carrier film may be configured such that when formed into a lamination architecture, the lamination architecture during the act of lamination is substantially mechanically isotropic in-plane. According to some embodiments, the disclosed materials may be chosen to form a laminated pancake optic having one or more of (a) good cosmetic appearance that is free or substantially free of tears or wrinkles, (b) uniform polarization optics, and (c) low surface forming error, exhibiting low optical distortion.

As illustrated in FIG. 5, when the pre-form is heated during lamination, a temperature gradient across the substrate and across the lamination architecture may be advantageously less than approximately 10° C., e.g., less than 10° C., less than 5° C., less than 2° C., or less than 1° C., including ranges between any of the foregoing values. In comparative processes, a temperature gradient across an area of the lens substrate may be 20° C. or more.

As illustrated in FIG. 5, an upper carrier film may be removed to expose a top surface of the shaped functional layer(s). The adhesive layers may include a UV releasable pressure sensitive adhesive, for example. Thereafter, a lens structure may be 3D printed over an exposed surface of the functional layer(s) to form a composite lens.

During 3D printing, a resinous source material may be heated and expelled as droplets through the nozzle of a printer head such that the droplets may alight on a surface of the pre-form and accumulate to form a hybrid meniscus lens. The printing step, which is shown schematically in FIG. 5, may be configured to manipulate and tune the optical properties of the resulting composite structure.

A 3D printing process may be used to form polymeric meniscus lenses not otherwise manufacturable by comparative methods such as injection molding or casting. The 3D printing process may incorporate a pixel-type printer head that is adapted to provide precise control of resin droplet size and droplet size distribution over a defined area. The radius of curvature of an example lens manufactured using the disclosed methods may range from approximately 30 mm to approximately 400 mm, e.g., 30, 50, 100, 150, 200, 250, 300, 350, or 400 mm, including ranges between any of the foregoing values.

Printed lenses may exhibit high quality surfaces, including roughness (RMS and PV), waviness, and orange peel, which may beneficially impact image quality metrics such as pupil swim and image distortion. The disclosed 3D printed meniscus lenses may be incorporated into the viewing optics of AR/VR glasses and headsets.

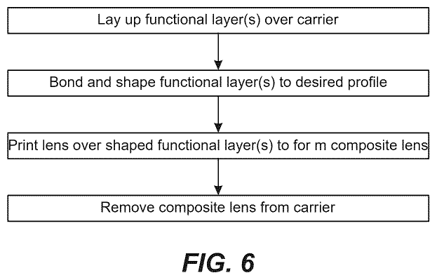

Following 3D printing, the composite lens may be de-bonded an removed from the mold and from the lower carrier film. An overview of an example process flow is outlined in FIG. 6.

A method of lens manufacture includes distinct and successive forming steps that respectively leverage lamination/molding and 3D printing technologies to create, for example, the viewing optics for AR/VR devices and headsets. In a first step, a molding process may be utilized to create a generalized form factor for the lens. The lens preform may be molded to include one or more functional layers, for example. In a subsequent step, one or more over-formed resin layers may be printed to tailor the final shape of the lens and accordingly define its optical properties including optical power, optical axis alignment, and axis-specific cylindricity.

In some embodiments, the multilayer optical film may be configured to introduce functionality such as polarization optics, retardation, antireflection, or diffractive optics. The improvement in raw material utilization associated with using a sized multilayer optical film may significantly benefit the economics of manufacture. Moreover, relative to direct lamination of an oversized multilayer optical film, the implementation of an oversized carrierfilm may improve in the resulting lens one or more attributes including cosmetic appearance, polarization uniformity, and surface forming error especially with respect to decreasing surface roughness. The disclosed hybrid lenses may be incorporated into the viewing optics of AR/VR glasses and headsets.

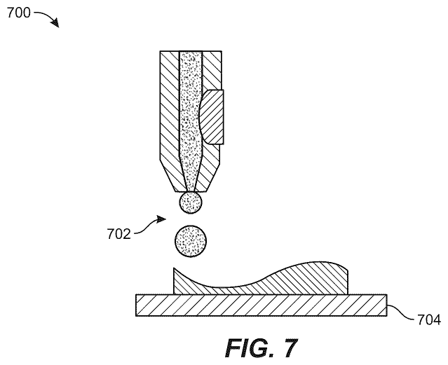

FIG. 7 is an illustration of an exemplary method for forming a polymer thin film 704 to model the polarization properties of a human eye. Inkjet 700 may include a liquid crystal polymer solution 702 configured to vary a thickness of the polymer thin film 704. As used herein, reference to a thin film may, in some examples, include reference to a layer of material ranging in thickness from a few nanometers (e.g., approximately 1 nm) to several micrometers (e.g., approximately 5000 am). In some embodiments, liquid crystal polymer solution 702 may include poly(ethylene glycol) (PEG), poly(propylene glycol) (PPG), poly(tetrahydrofuran) (PTHF), poly(dimethylsiloxane) (PDMS), poly(methylphenylsiloxane) (PMPS), and the like, although further liquid crystal polymer materials are contemplated. In some embodiments, polymer thin film 704 may include a polymer selected from the group consisting of polyethylene naphthalate, polyethylene terephthalate, polybutylene terephthalate, polytetrafluoroethylene, polyoxymethylene, aliphatic or semi-aromatic polyamides, ethylene vinyl alcohol, polyvinylidene fluoride, isotactic polypropylene, and polyethylene. In some embodiments, the polymer thin film thickness may be between approximately 100 nm and approximately 20 μm, although lesser and greater thicknesses are contemplated. As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

In some embodiments, inkjet 700 may utilize a technique known as inkjet printing. In some embodiments, inkjet printing may refer to a type of printing that operates by propelling droplets of liquid crystal polymer solution 702 onto the polymer thin film 704. Inkjet printing the liquid crystal polymer solution 702 may vary a thickness layer for further refinement of the polymer thin film 704. Using the liquid crystal polymer solution 702 may simulate polarization properties such as birefringence because liquid crystal polymer solution 702 may refine the thickness layer of the polymer thin film 704 to manipulate the way a light may travel. More specifically, varying the thickness layer can create a thickness variation and localized patterning of a fast axis. As used herein, “fast axis” can generally refer to the local alignment of a uniaxial crystalline material In this manner, localized patterning of the fast axis may model a birefringence distribution in a human eye.

As used herein, “birefringence” can generally refer to a material that has varying refractive indices depending on the polarization and direction of light. For example, the cornea, the eye's outermost layer, is naturally birefringent because the fiber structure of the cornea may cause the refractive index to differ for light polarized in different directions. In this manner, the cornea may have a radially varying fast axis where the direction of the fast axis may change as light is reflected away from the center of the cornea. Therefore, localized patterning of the polymer thin film 704 may model a birefringence distribution of the cornea because the localized patterning of the fast axis may control the polarization of light. In doing so, the polymer thin film 704 may replicate a radially varying fast axis and model a birefringence distribution similar to that of a cornea. Furthermore, localized patterning of the polymer thin film 704 may also model a non-uniform polarizing behavior of the human eye.

In some embodiments, the liquid crystal polymer solution 702 can enable the modeling of other polarization properties such as retardance and diattenuation. Inkjet printing the liquid crystal polymer solution 702 in addition to a local concentration of dichroic dye can model the polarization properties of retardance and diattenuation. As used herein, “dichroic dyes” can generally refer to materials that exhibit different absorption for light polarized in different directions. As used herein, “retardance” can generally refer to the phase difference introduced between two orthogonal polarization components of light as it passes through a birefringent material. Therefore, by varying a local concentration and orientation of dichroic dye molecules in a material, the dye molecules may align in a way that affects the phase of incoming polarized light, inducing a difference in phase between two perpendicular polarization components. As used herein, “diattenuation” can generally refer to the differential absorption of light depending on its polarization state. Therefore, by controlling a local concentration and orientation of dichroic dye molecules, an amount of absorption can be modeled for different polarization states.

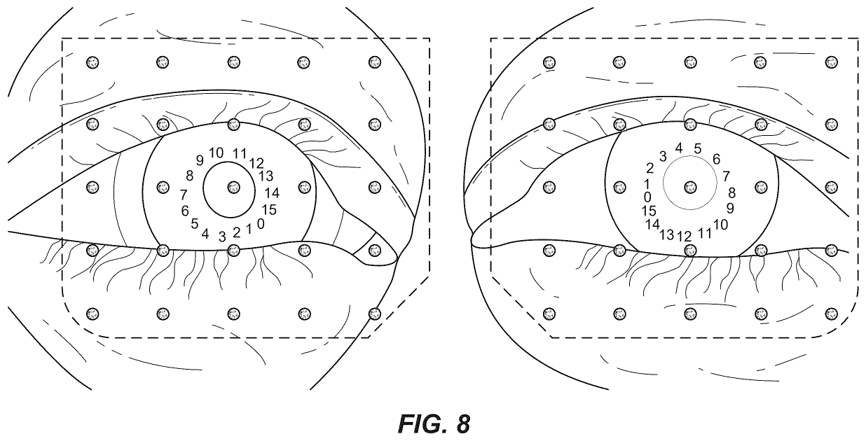

FIG. 8 illustrates an array of sensors for determining a gaze direction of a user's eye. In one example, the disclosed systems and methods for improved optical eye-tracking may include collecting optical signals from each volume hologram into an optical fiber (e.g., telecommunication cylindrical fiber) embedded within the volume of the photosensitive layer and/or placed behind the photosensitive layer in locations matching the positions of the volume holograms.

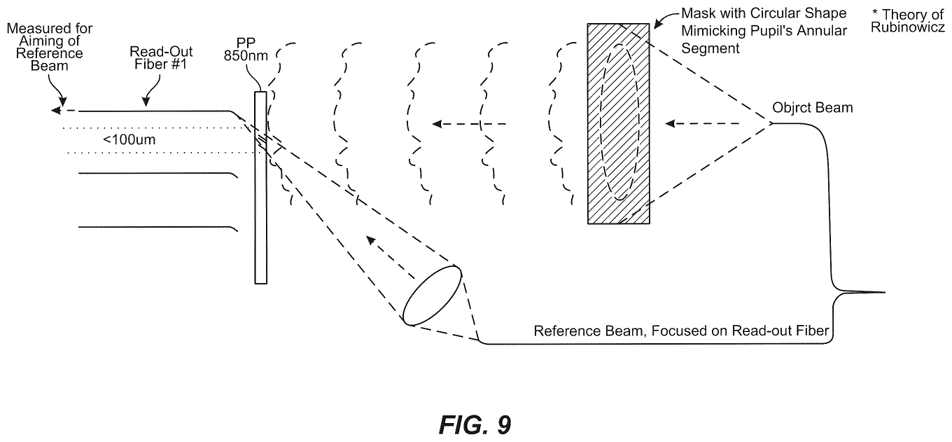

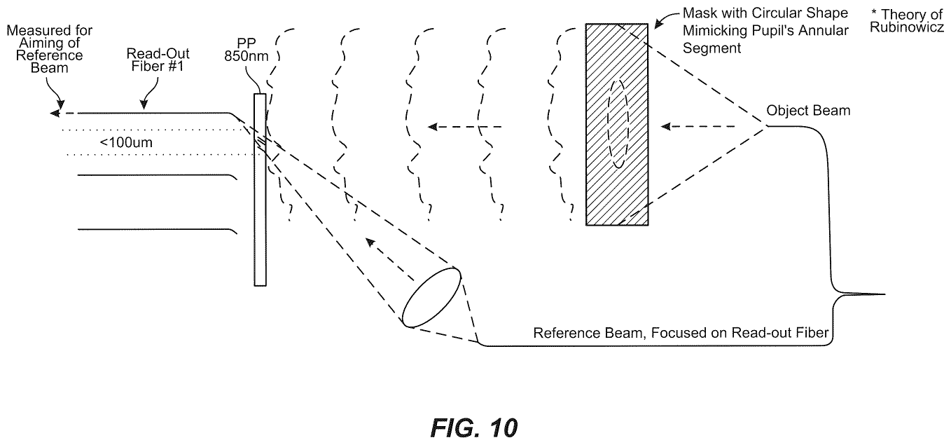

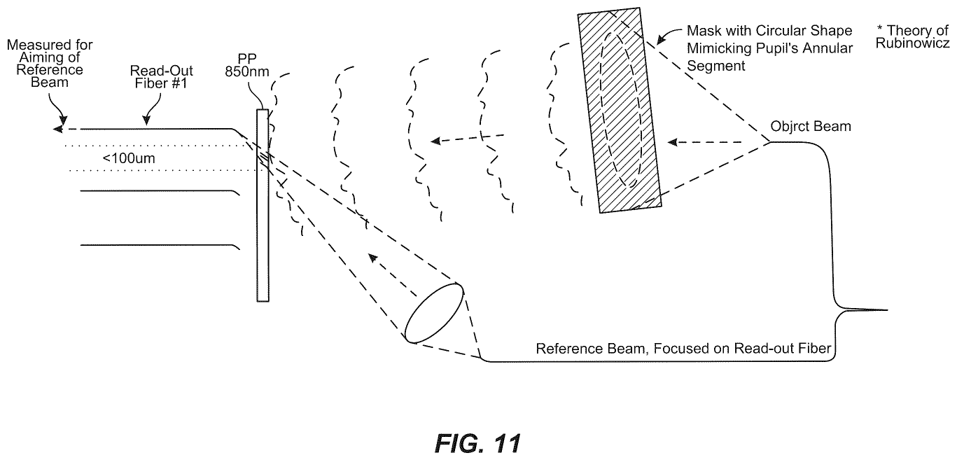

FIGS. 9-11 illustrate an optical elements that are fabricated using a circular pattern. Referring to FIG. 9 an optical element is fabricated using a circular pattern, whereas in FIG. 10 the optical element is fabricated using differently sized circular patterns. Similar, FIG. 11 illustrates how the optical element is fabricated using off-axis circular patterns of an optical beam to create a diffractive structure sensitive to symmetrical objects within its field of view.

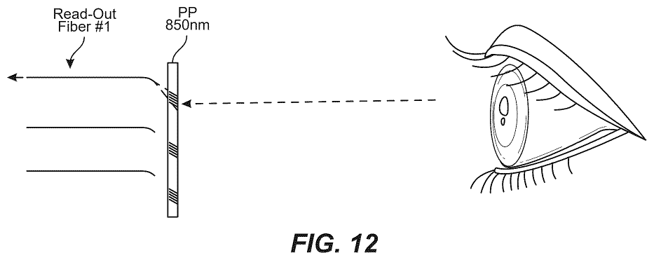

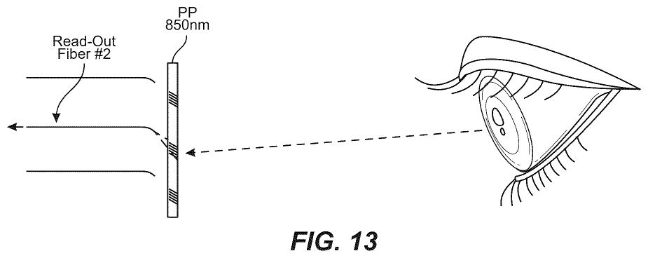

FIGS. 12-13 illustrate how a gaze of a user's eye is used to collect optical output signals from a first optical fiber and a second optical fiber. Each optical fiber may include a telecommunication-grade fiber integrated detector, capable of converting the optical signals from each optical fiber into an electrical signal. For example, signals from the volume holograms and the optical fibers may be compared to identify the detector generating the highest measurable electrical signal focused on the core of the associated optical fiber (e.g., signal read-out fiber). The identified detector producing the highest measurable electrical signal may correspond to the detector aligned with the user's direct gaze. In some instances, the alignment of the user's gaze with the detector may be utilized to determine both the position of the center of rotation and a gaze angle of the user's eye.

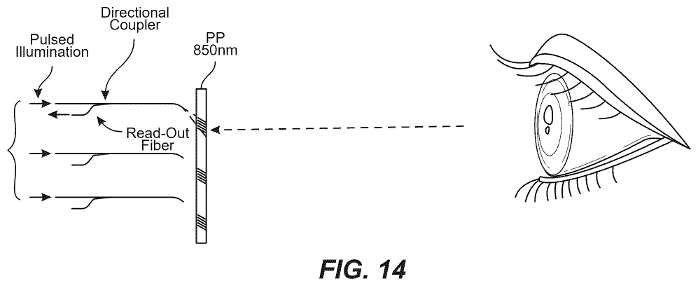

FIG. 14 illustrates a gaze of a user's eye for collecting an optical output signal from an optical fiber for illuminating the eye. In some embodiments, the disclosed systems may utilize illumination methods, where an optical fiber is used for illuminating the eye of the user and capturing the reflected optical signal. The returning optical signal from the volume hologram may be separated from the incoming optical beam by a directional fiber coupler. In some examples, the illumination methods may yield controlled phase relationships around the edges of the pupil and/or iris of a user. In some examples, the illumination methods may enable enhanced uniform illumination intensity. In some examples, the illumination methods may include a pulsed illumination mode, where the optical beam may pulse sequentially to each optical fiber (i.e., each optical fiber is fed one by one so that no spurious glints and/or reflection from the cornea are created). Additionally, the illumination methods may be advantageous due to additional reflection created from the retina (e.g., red-eye effect), resulting in a higher contrast between the pupil and the iris and stronger diffraction at the edges of the pupil. In some examples, the illumination methods may further include alternative methods including flood illumination via a light source (e.g., lasers, light-emitting diodes, optical beams) and/or operating passively with an ambient light source.

In some embodiments, the disclosed systems and methods may further include exposing an array of volume holograms in a photosensitive layer. Each volume hologram may be represented as a volumetric set of fringes (e.g., periodic variations of the index of refraction, delta n) in the photosensitive layer. For example, an interference beam focused on the optical fibers and an object beam may form the volumetric fringes. For example, focusing the interference beam includes real-time focusing control. For example, the object beam is formed by coherent light (e.g., laser) passing through a mask representing a circular shape. Exposing the array of volume holograms in the photosensitive layer in this way may enable the volume holograms to detect circular objects, such as the human pupil, with enhanced precision.

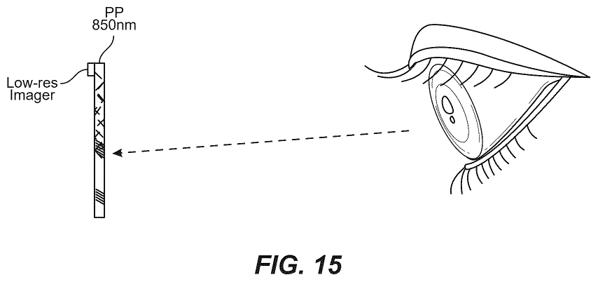

FIG. 15 illustrates an optical element fabricated using off-axis circular patterns of an optical beam generated by a volume hologram including total internal reflection (TIR). In further embodiments, the optical beam generated by a volume hologram may undergo total internal reflection (TIR) within the photosensitive layer. The TIR may repeat in multiple instances, where the optical beam may reach an imager (e.g., a low-resolution Complementary metal-oxide-semiconductor imager and/or a light-sensitive integrated circuit imager) placed proximal to the photosensitive layer. The imager may capture coordinates of an optical signal, which are directly transformed into gaze angles. In some embodiments, the photosensitive layer may act as an optical filter, where the photosensitive layer may be used to separate optical beams of light used for sensing from other ambient light sources. In some embodiments, the photosensitive layer may sense various features from different optical spectrum regions (e.g., optical spectrum regions including ultraviolet, visible light, Infrared, terahertz, etc.).

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

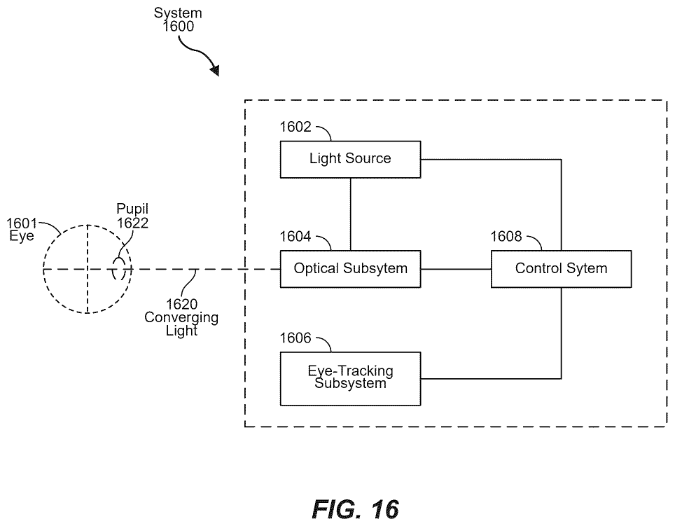

FIG. 16 is an illustration of an example system 1600 that incorporates an eye-tracking subsystem capable of tracking a user's eye(s). As depicted in FIG. 16, system 1600 may include a light source 1602, an optical subsystem 1604, an eye-tracking subsystem 1606, and/or a control subsystem 1608. In some examples, light source 1602 may generate light for an image (e.g., to be presented to an eye 1601 of the viewer). Light source 1602 may represent any of a variety of suitable devices. For example, light source 1602 can include a two-dimensional projector (e.g., a LCoS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 1604 may receive the light generated by light source 1602 and generate, based on the received light, converging light 1620 that includes the image. In some examples, optical subsystem 1604 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 1620. Further, various mechanical couplings may serve to maintain the relative spacing and/or the orientation of the optical components in any suitable combination.

In one embodiment, eye-tracking subsystem 1606 may generate tracking information indicating a gaze angle of an eye 1601 of the viewer. In this embodiment, control subsystem 1608 may control aspects of optical subsystem 1604 (e.g., the angle of incidence of converging light 1620) based at least in part on this tracking information. Additionally, in some examples, control subsystem 1608 may store and utilize historical tracking information (e.g., a history of the tracking information over a given duration, such as the previous second or fraction thereof) to anticipate the gaze angle of eye 1601 (e.g., an angle between the visual axis and the anatomical axis of eye 1601). In some embodiments, eye-tracking subsystem 1606 may detect radiation emanating from some portion of eye 1601 (e.g., the cornea, the iris, the pupil, or the like) to determine the current gaze angle of eye 1601. In other examples, eye-tracking subsystem 1606 may employ a wavefront sensor to track the current location of the pupil.

Any number of techniques can be used to track eye 1601. Some techniques may involve illuminating eye 1601 with infrared light and measuring reflections with at least one optical sensor that is tuned to be sensitive to the infrared light. Information about how the infrared light is reflected from eye 1601 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 1606 may be digitized (i.e., converted to an electronic signal). Further, the sensor may transmit a digital representation of this electronic signal to one or more processors (for example, processors associated with a device including eye-tracking subsystem 1606). Eye-tracking subsystem 1606 may include any of a variety of sensors in a variety of different configurations. For example, eye-tracking subsystem 1606 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 1606 to track the movement of eye 1601. In another example, these processors may track the movements of eye 1601 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 1606 may be programmed to use an output of the sensor(s) to track movement of eye 1601. In some embodiments, eye-tracking subsystem 1606 may analyze the digital representation generated by the sensors to extract eye rotation information from changes in reflections. In one embodiment, eye-tracking subsystem 1606 may use corneal reflections or glints (also known as Purkinje images) and/or the center of the eye's pupil 1622 as features to track over time.

In some embodiments, eye-tracking subsystem 1606 may use the center of the eye's pupil 1622 and infrared or near-infrared, non-collimated light to create corneal reflections. In these embodiments, eye-tracking subsystem 1606 may use the vector between the center of the eye's pupil 1622 and the corneal reflections to compute the gaze direction of eye 1601. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 1606 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 1601 may act as a retroreflector as the light reflects off the retina, thereby creating a bright pupil effect similar to a red-eye effect in photography. If the illumination source is offset from the optical path, then the eye's pupil 1622 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 1608 may control light source 1602 and/or optical subsystem 1604 to reduce optical aberrations (e.g., chromatic aberrations and/or monochromatic aberrations) of the image that may be caused by or influenced by eye 1601. In some examples, as mentioned above, control subsystem 1608 may use the tracking information from eye-tracking subsystem 1606 to perform such control. For example, in controlling light source 1602, control subsystem 1608 may alter the light generated by light source 1602 (e.g., by way of image rendering) to modify (e.g., pre-distort) the image so that the aberration of the image caused by eye 1601 is reduced.

The disclosed systems maytrack both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

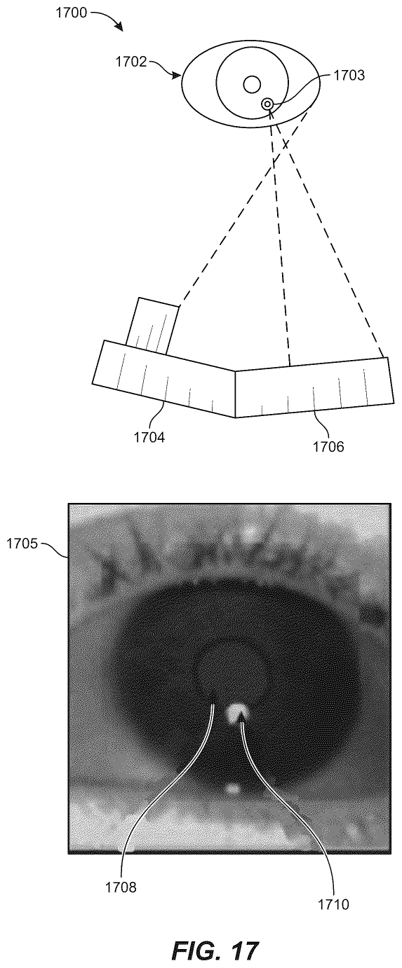

FIG. 17 is a more detailed illustration of various aspects of the eye-tracking subsystem illustrated in FIG. 16. As shown in this figure, an eye-tracking subsystem 1700 may include at least one source 1704 and at least one sensor 1706. Source 1704 generally represents any type or form of element capable of emitting radiation. In one example, source 1704 may generate visible, infrared, and/or near-infrared radiation. In some examples, source 1704 may radiate non-collimated infrared and/or near-infrared portions of the electromagnetic spectrum towards an eye 1702 of a user. Source 1704 may utilize a variety of sampling rates and speeds. For example, the disclosed systems may use sources with higher sampling rates in order to capture fixational eye movements of a user's eye 1702 and/or to correctly measure saccade dynamics of the user's eye 1702. As noted above, any type or form of eye-tracking technique may be used to track the user's eye 1702, including optical-based eye-tracking techniques, ultrasound-based eye-tracking techniques, etc.

Sensor 1706 generally represents any type or form of element capable of detecting radiation, such as radiation reflected off the user's eye 1702. Examples of sensor 1706 include, without limitation, a charge coupled device (CCD), a photodiode array, a complementary metal-oxide-semiconductor (CMOS) based sensor device, and/or the like. In one example, sensor 1706 may represent a sensor having predetermined parameters, including, but not limited to, a dynamic resolution range, linearity, and/or other characteristic selected and/or designed specifically for eye tracking.

As detailed above, eye-tracking subsystem 1700 may generate one or more glints. As detailed above, a glint 1703 may represent reflections of radiation (e.g., infrared radiation from an infrared source, such as source 1704) from the structure of the user's eye. In various embodiments, glint 1703 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 17 shows an example image 1705 captured by an eye-tracking subsystem, such as eye-tracking subsystem 1700. In this example, image 1705 may include both the user's pupil 1708 and a glint 1710 near the same. In some examples, pupil 1708 and/or glint 1710 may be identified using an artificial-intelligence-based algorithm, such as a computer-vision-based algorithm. In one embodiment, image 1705 may represent a single frame in a series of frames that may be analyzed continuously in order to track the eye 1702 of the user. Further, pupil 1708 and/or glint 1710 may be tracked over a period of time to determine a user's gaze.

In one example, eye-tracking subsystem 1700 may be configured to identify and measure the inter-pupillary distance (IPD) of a user. In some embodiments, eye-tracking subsystem 1700 may measure and/or calculate the IPD of the user while the user is wearing the artificial reality system. In these embodiments, eye-tracking subsystem 1700 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more of the various components of system 1600 and/or eye-tracking subsystem 1700 may be incorporated into any of the augmented-reality systems in and/or virtual-reality systems described herein in to enable these systems to perform various eye-tracking tasks (including one or more of the eye-tracking operations described herein).

### EXAMPLE EMBODIMENTS

Example 1: A method comprising forming a polymer thin film and inkjet printing a liquid crystal polymer solution over the polymer thin film to vary a thickness layer of the polymer thin film for modeling polarization properties of a human eye.

Example 2: The method of claim 1, where inkjet printing the liquid crystal polymer solution allows for a localized patterning of a fast axis.

Example 3: The method of any of Examples 1 and 2, where the localized patterning of the polymer thin film models a birefringence distribution of the human eye.

Example 4: The method of any of Examples 1-3, where the polymer thin film comprises a polymer selected from the group consisting of polyethylene naphthalate, polyethylene terephthalate, polybutylene terephthalate, polytetrafluoroethylene, polyoxymethylene, aliphatic or semi-aromatic polyamides, ethylene vinyl alcohol, polyvinylidene fluoride, isotactic polypropylene, and polyethylene.

Example 5: The method of any of Examples 1-4, where the liquid crystal polymer solution comprises poly(ethylene glycol) (PEG), poly(propylene glycol) (PPG), poly(tetrahydrofuran) (PTHF), poly(dimethylsiloxane) (PDMS), poly(methylphenylsiloxane) (PMPS).

Example 6: The method of any of Examples 1-5, where inkjet printing further comprises modeling a non-uniform behavior of the human eye.

Example 7: The method of any of Examples 1-6, where the polarization properties further comprise retardance and diattenuation.

Example 8: The method of any of Examples 1-7, where the polymer thin film thickness is between approximately 100 nm and approximately 20 microns.

Example 9: The method of any of Examples 1-8, where the polymer thin film further comprises modeling scattering such as haze of the human eye.

Example 10: The method of any of Examples 1-9, where inkjet printing further comprises adding in a dichroic dye to the liquid crystal polymer solution to model the polarization properties of retardance and diattenuation.

Example 11: A method includes thermo-forming a functional optical layer to a specified shape, and depositing a layer of a resin composition over a surface of the shaped functional optical layer to form a compound lens.

Example 12: The method of Example 11, where the functional optical layer includes a reflective polarizer and an optical retarder.

Example 13: The method of any of Examples 11 and 12, where the depositing includes 3D printing.

Example 14: The method of any of Examples 11-13, where during the depositing an average droplet size of the resin composition is at least approximately 500 nm.

Example 15: The method of any of Examples 11-14, where the resin composition includes a UV curable compound.

Example 16: The method of any of Examples 11-15, further including irradiating, for curing, the layer of the resin composition.

Example 17: A method comprising forming a polymer thin film and inkjet printing a liquid crystal polymer solution over the polymer thin film to vary a thickness layer of the polymer thin film for modeling polarization properties of a human eye.

Example 18: The method of claim 1, where inkjet printing the liquid crystal polymer solution allows for a localized patterning of a fast axis.

Example 19: The method of any of Examples 17 and 18, where the localized patterning of the polymer thin film models a birefringence distribution of the human eye.

Example 20: The method of any of Examples 21-23, where the polymer thin film comprises a polymer selected from the group consisting of polyethylene naphthalate, polyethylene terephthalate, polybutylene terephthalate, polytetrafluoroethylene, polyoxymethylene, aliphatic or semi-aromatic polyamides, ethylene vinyl alcohol, polyvinylidene fluoride, isotactic polypropylene, and polyethylene.

Example 21: The method of any of Examples 17-20, where the liquid crystal polymer solution comprises poly(ethylene glycol) (PEG), poly(propylene glycol) (PPG), poly(tetrahydrofuran) (PTHF), poly(dimethylsiloxane) (PDMS), poly(methylphenylsiloxane) (PMPS).

Example 22: The method of any of Examples 17-21, where inkjet printing further comprises modeling a non-uniform behavior of the human eye.

Example 23: The method of any of Examples 17-22, where the polarization properties further comprise retardance and diattenuation.

Example 24: The method of any of Examples 17-23, where the polymer thin film thickness is between approximately 100 nm and approximately 20 microns.

Example 25: The method of any of Examples 17-24, where the polymer thin film further comprises modeling scattering such as haze of the human eye.

Example 26: The method of any of Examples 17-25, where inkjet printing further comprises adding in a dichroic dye to the liquid crystal polymer solution to model the polarization properties of retardance and diattenuation.

Example 27: A method comprising (i) exposing an array of detectors in a photosensitive layer, (ii) detecting a circular object via the array of detectors, (iii) collecting an optical output signal from each detector through a corresponding optical fiber, and (iv) converting the optical output signal from each optical fiber into an electrical signal and determining a gaze direction of a user's eye based on the electrical signal

Example 28: The method of Example 27, where each optical fiber is a telecommunication fiber embedded within the photosensitive layer. Human eye

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed- or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

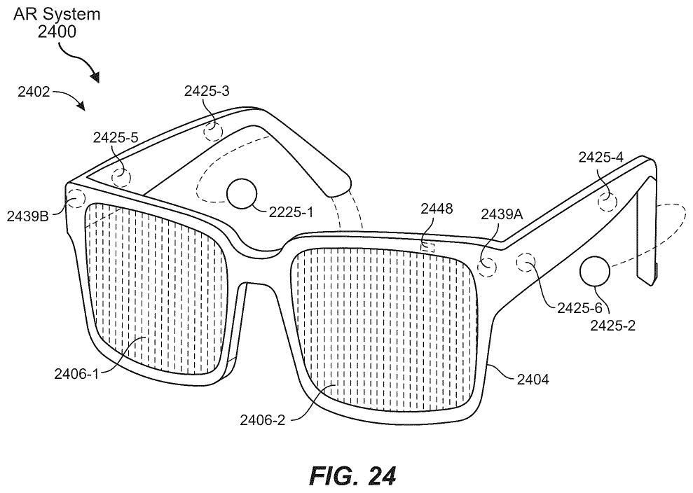

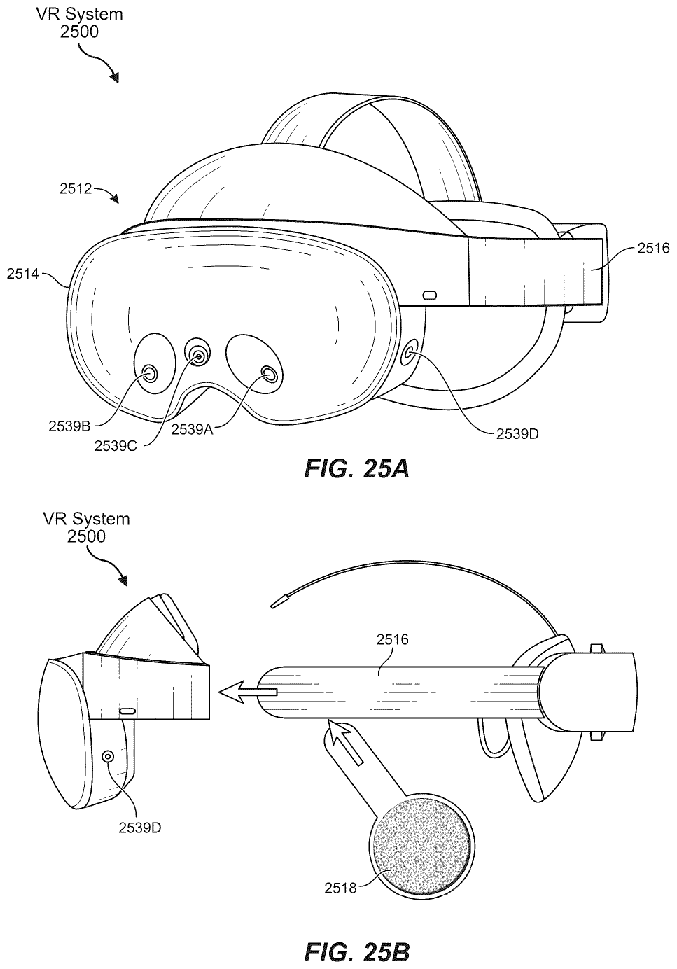

AR systems may be implemented in a variety of different form factors and configurations. Some AR systems may be designed to work without near-eye displays (NEDs). Other AR systems may include a NED that also provides visibility into the real world (such as, e.g., augmented-reality system 2400 in FIG. 24) or that visually immerses a user in an artificial reality (such as, e.g., virtual-reality system 2500 in FIGS. 25A and 25B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

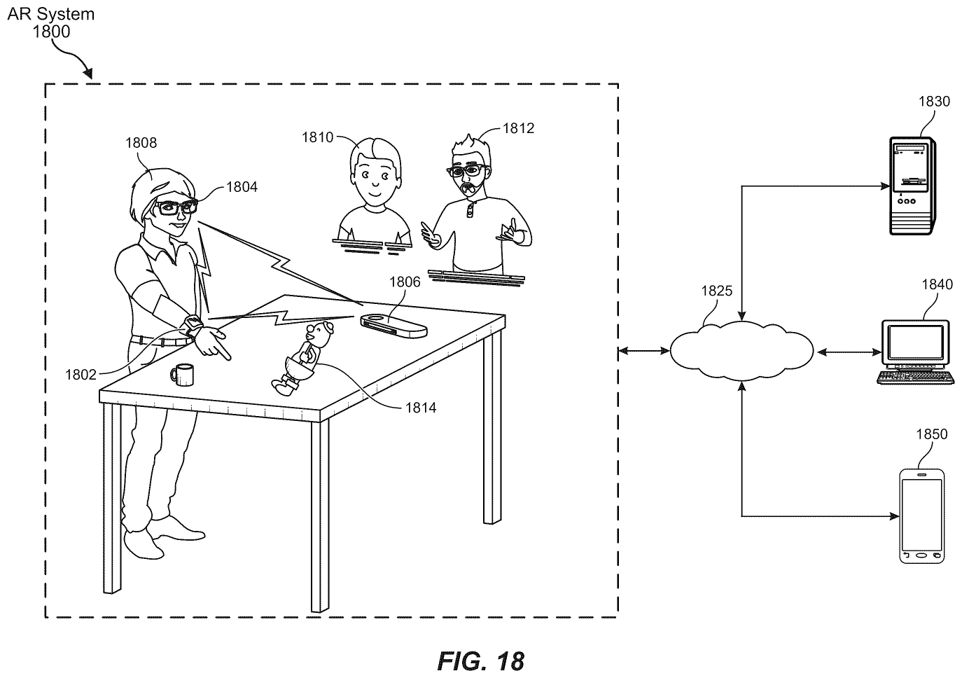

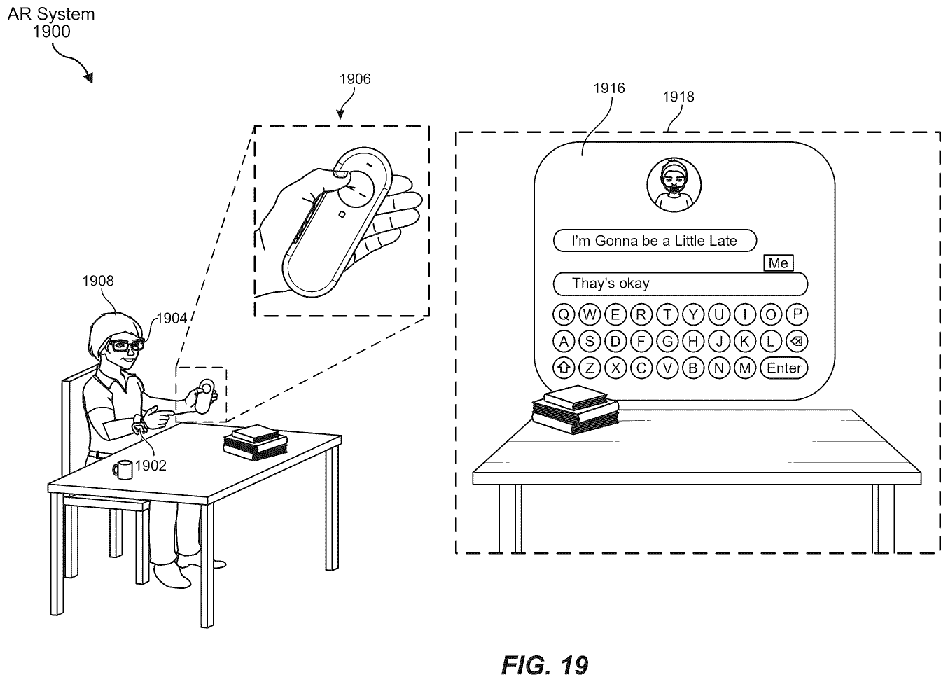

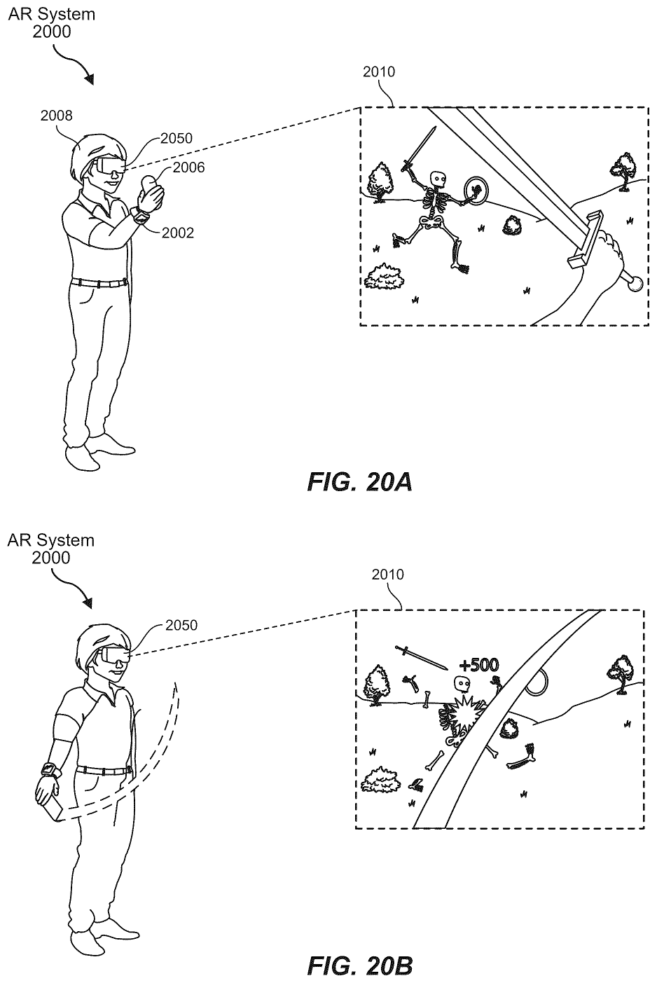

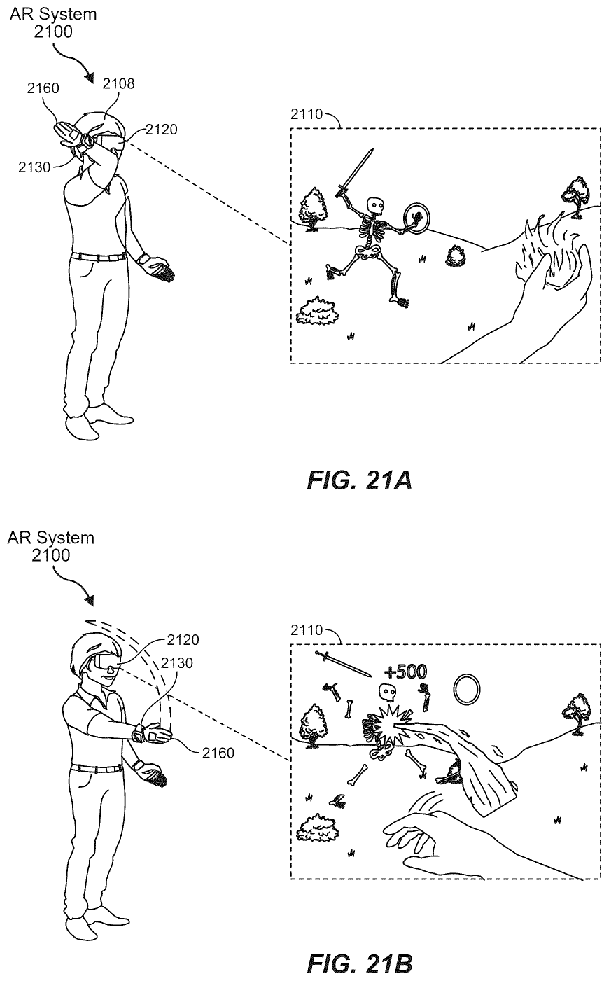

FIGS. 18-21B illustrate example artificial-reality (AR) systems in accordance with some embodiments. FIG. 18 shows a first AR system 1800 and first example user interactions using a wrist-wearable device 1802, a head-wearable device (e.g., AR glasses 2400), and/or a handheld intermediary processing device (HIPD) 1806. FIG. 19 shows a second AR system 1900 and second example user interactions using a wrist-wearable device 1902, AR glasses 1904, and/or an HIPD 1906. FIGS. 20A and 20B show a third AR system 2000 and third example user 2008 interactions using a wrist-wearable device 2002, a head-wearable device (e.g., VR headset 2050), and/or an HIPD 2006. FIGS. 21A and 21B show a fourth AR system 2100 and fourth example user 2108 interactions using a wrist-wearable device 2130, VR headset 2120, and/or a haptic device 2160 (e.g., wearable gloves).

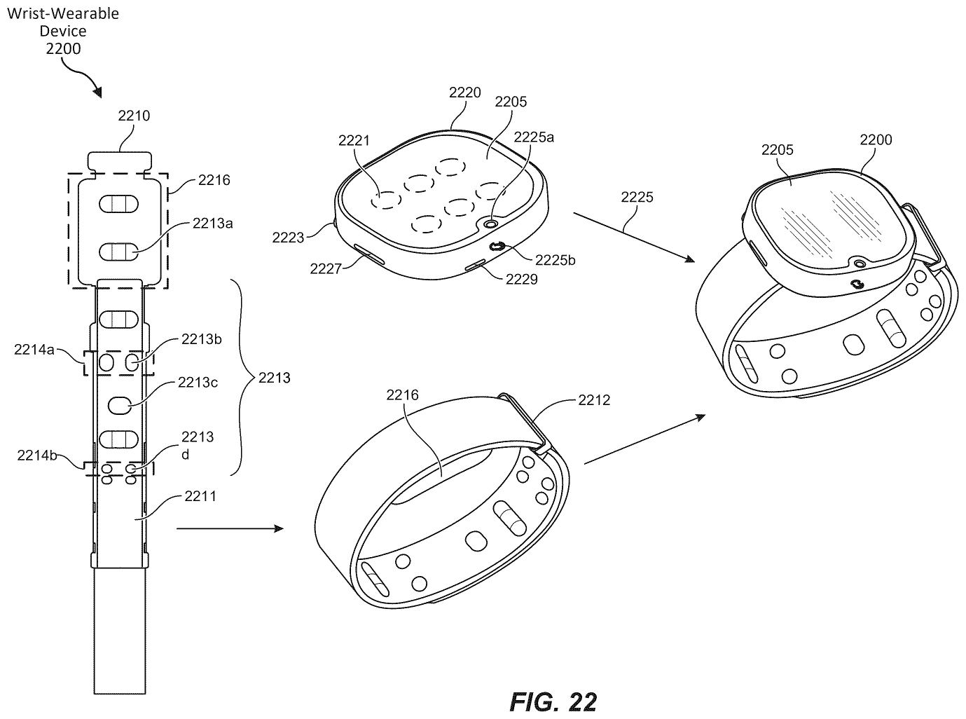

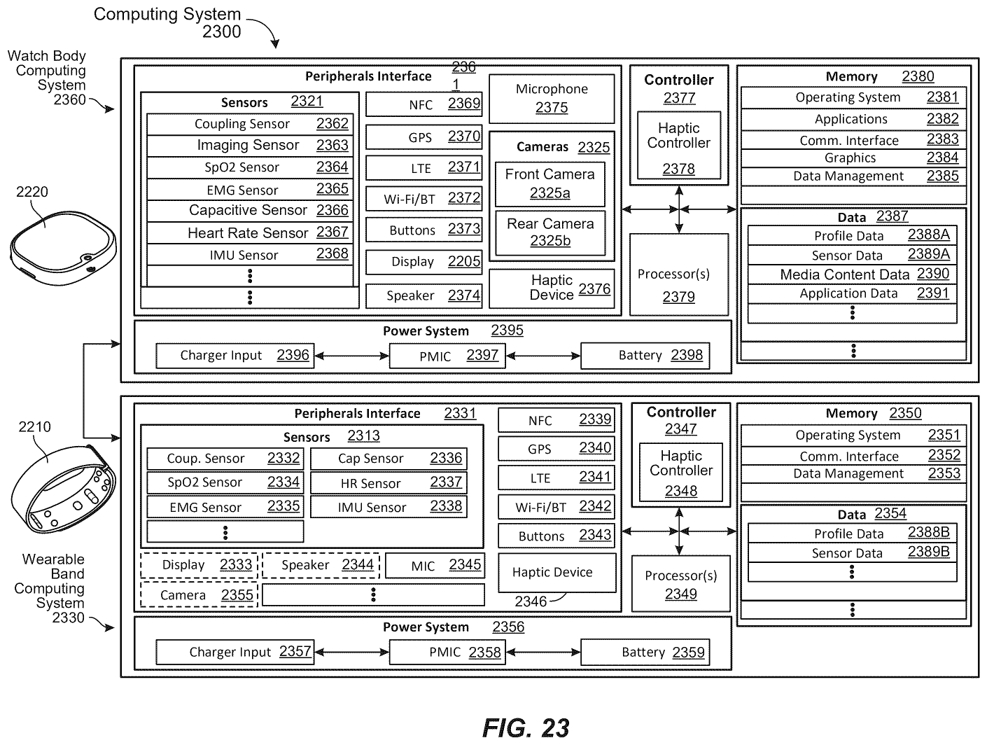

A wrist-wearable device 2200, which can be used for wrist-wearable device 1802, 1902, 2002, 2130, and one or more of its components, are described below in reference to FIGS. 22 and 23; head-wearable devices 2400 and 2500, which can respectively be used for AR glasses 1804, 1904 or VR headset 2050, 2120, and their one or more components are described below in reference to FIGS. 24-26.

Referring to FIG. 18, wrist-wearable device 1802, AR glasses 1804, and/or HIPD 1806 can communicatively couple via a network 1825 (e.g., cellular, near field, Wi-Fi, personal area network, wireless LAN, etc.). Additionally, wrist-wearable device 1802, AR glasses 1804, and/or HIPD 1806 can also communicatively couple with one or more servers 1830, computers 1840 (e.g., laptops, computers, etc.), mobile devices 1850 (e.g., smartphones, tablets, etc.), and/or other electronic devices via network 1825 (e.g., cellular, near field, Wi-Fi, personal area network, wireless LAN, etc.).

In FIG. 18, a user 1808 is shown wearing wrist-wearable device 1802 and AR glasses 1804 and having HIPD 1806 on their desk. The wrist-wearable device 1802, AR glasses 1804, and HIPD 1806 facilitate user interaction with an AR environment. In particular, as shown by first AR system 1800, wrist-wearable device 1802, AR glasses 1804, and/or HIPD 1806 cause presentation of one or more avatars 1810, digital representations of contacts 1812, and virtual objects 1814. As discussed below, user 1808 can interact with one or more avatars 1810, digital representations of contacts 1812, and virtual objects 1814 via wrist-wearable device 1802, AR glasses 1804, and/or HIPD 1806.

User 1808 can use any of wrist-wearable device 1802, AR glasses 1804, and/or HIPD 1806 to provide user inputs. For example, user 1808 can perform one or more hand gestures that are detected by wrist-wearable device 1802 (e.g., using one or more EMG sensors and/or IMUs, described below in reference to FIGS. 22 and 23) and/or AR glasses 1804 (e.g., using one or more image sensor or camera, described below in reference to FIGS. 24-26) to provide a user input. Alternatively, or additionally, user 1808 can provide a user input via one or more touch surfaces of wrist-wearable device 1802, AR glasses 1804, HIPD 1806, and/or voice commands captured by a microphone of wrist-wearable device 1802, AR glasses 1804, and/or HIPD 1806. In some embodiments, wrist-wearable device 1802, AR glasses 1804, and/or HIPD 1806 include a digital assistant to help user 1808 in providing a user input (e.g., completing a sequence of operations, suggesting different operations or commands, providing reminders, confirming a command, etc.). In some embodiments, user 1808 can provide a user input via one or more facial gestures and/or facial expressions. For example, cameras of wrist-wearable device 1802, AR glasses 1804, and/or HIPD 1806 can track eyes of user 1808 for navigating a user interface.

Wrist-wearable device 1802, AR glasses 1804, and/or HIPD 1806 can operate alone or in conjunction to allow user 1808 to interact with the AR environment. In some embodiments, HIPD 1806 is configured to operate as a central hub or control center for the wrist-wearable device 1802, AR glasses 1804, and/or another communicatively coupled device. For example, user 1808 can provide an input to interact with the AR environment at any of wrist-wearable device 1802, AR glasses 1804, and/or HIPD 1806, and HIPD 1806 can identify one or more back-end and front-end tasks to cause the performance of the requested interaction and distribute instructions to cause the performance ofthe one or more back-end and front-end tasks at wrist-wearable device 1802, AR glasses 1804, and/or HIPD 1806. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). HIPD 1806 can perform the back-end tasks and provide wrist-wearable device 1802 and/or AR glasses 1804 operational data corresponding to the performed back-end tasks such that wrist-wearable device 1802 and/or AR glasses 1804 can perform the front-end tasks. In this way, HIPD 1806, which has more computational resources and greater thermal headroom than wrist-wearable device 1802 and/or AR glasses 1804, performs computationally intensive tasks and reduces the computer resource utilization and/or power usage of wrist-wearable device 1802 and/or AR glasses 1804.

In the example shown by first AR system 1800, HIPD 1806 identifies one or more back-end tasks and front-end tasks associated with a user request to initiate an AR video call with one or more other users (represented by avatar 1810 and the digital representation of contact 1812) and distributes instructions to cause the performance of the one or more back-end tasks and front-end tasks. In particular, HIPD 1806 performs back-end tasks for processing and/or rendering image data (and other data) associated with the AR video call and provides operational data associated with the performed back-end tasks to AR glasses 1804 such that the AR glasses 1804 perform front-end tasks for presenting the AR video call (e.g., presenting avatar 1810 and digital representation of contact 1812).

In some embodiments, HIPD 1806 can operate as a focal or anchor point for causing the presentation of information. This allows user 1808 to be generally aware of where information is presented. For example, as shown in first AR system 1800, avatar 1810 and the digital representation of contact 1812 are presented above HIPD 1806. In particular, HIPD 1806 and AR glasses 1804 operate in conjunction to determine a location for presenting avatar 1810 and the digital representation of contact 1812. In some embodiments, information can be presented a predetermined distance from HIPD 1806 (e.g., within 5 meters). For example, as shown in first AR system 1800, virtual object 1814 is presented on the desk some distance from HIPD 1806. Similar to the above example, HIPD 1806 and AR glasses 1804 can operate in conjunction to determine a location for presenting virtual object 1814. Alternatively, in some embodiments, presentation of information is not bound by HIPD 1806. More specifically, avatar 1810, digital representation of contact 1812, and virtual object 1814 do not have to be presented within a predetermined distance of HIPD 1806.

User inputs provided at wrist-wearable device 1802, AR glasses 1804, and/or HIPD 1806 are coordinated such that the user can use any device to initiate, continue, and/or complete an operation. For example, user 1808 can provide a user input to AR glasses 1804 to cause AR glasses 1804 to present virtual object 1814 and, while virtual object 1814 is presented by AR glasses 1804, user 1808 can provide one or more hand gestures via wrist-wearable device 1802 to interact and/or manipulate virtual object 1814.

FIG. 19 shows a user 1908 wearing a wrist-wearable device 1902 and AR glasses 1904, and holding an HIPD 1906. In second AR system 1900, the wrist-wearable device 1902, AR glasses 1904, and/or HIPD 1906 are used to receive and/or provide one or more messages to a contact of user 1908. In particular, wrist-wearable device 1902, AR glasses 1904, and/or HIPD 1906 detect and coordinate one or more user inputs to initiate a messaging application and prepare a response to a received message via the messaging application.

In some embodiments, user 1908 initiates, via a user input, an application on wrist-wearable device 1902, AR glasses 1904, and/or HIPD 1906 that causes the application to initiate on at least one device. For example, in second AR system 1900, user 1908 performs a hand gesture associated with a command for initiating a messaging application (represented by messaging user interface 1916), wrist-wearable device 1902 detects the hand gesture and, based on a determination that user 1908 is wearing AR glasses 1904, causes AR glasses 1904 to present a messaging user interface 1916 of the messaging application. AR glasses 1904 can present messaging user interface 1916 to user 1908 via its display (e.g., as shown by a field of view 1918 of user 1908). In some embodiments, the application is initiated and executed on the device (e.g., wrist-wearable device 1902, AR glasses 1904, and/or HIPD 1906) that detects the user input to initiate the application, and the device provides another device operational data to cause the presentation of the messaging application. For example, wrist-wearable device 1902 can detect the user input to initiate a messaging application, initiate and run the messaging application, and provide operational data to AR glasses 1904 and/or HIPD 1906 to cause presentation of the messaging application. Alternatively, the application can be initiated and executed at a device other than the device that detected the user input. For example, wrist-wearable device 1902 can detect the hand gesture associated with initiating the messaging application and cause HIPD 1906 to run the messaging application and coordinate the presentation of the messaging application.

Further, user 1908 can provide a user input provided at wrist-wearable device 1902, AR glasses 1904, and/or HIPD 1906 to continue and/or complete an operation initiated at another device. For example, after initiating the messaging application via wrist-wearable device 1902 and while AR glasses 1904 present messaging user interface 1916, user 1908 can provide an input at HIPD 1906 to prepare a response (e.g., shown by the swipe gesture performed on HIPD 1906). Gestures performed by user 1908 on HIPD 1906 can be provided and/or displayed on another device. For example, a swipe gestured performed on HIPD 1906 is displayed on a virtual keyboard of messaging user interface 1916 displayed by AR glasses 1904.

In some embodiments, wrist-wearable device 1902, AR glasses 1904, HIPD 1906, and/or any other communicatively coupled device can present one or more notifications to user 1908. The notification can be an indication of a new message, an incoming call, an application update, a status update, etc. User 1908 can select the notification via wrist-wearable device 1902, AR glasses 1904, and/or HIPD 1906 and can cause presentation of an application or operation associated with the notification on at least one device. For example, user 1908 can receive a notification that a message was received at wrist-wearable device 1902, AR glasses 1904, HIPD 1906, and/or any other communicatively coupled device and can then provide a user input at wrist-wearable device 1902, AR glasses 1904, and/or HIPD 1906 to review the notification, and the device detecting the user input can cause an application associated with the notification to be initiated and/or presented at wrist-wearable device 1902, AR glasses 1904, and/or HIPD 1906.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 1904 can present to user 1908 game application data, and HIPD 1906 can be used as a controller to provide inputs to the game. Similarly, user 1908 can use wrist-wearable device 1902 to initiate a camera of AR glasses 1904, and user 1908 can use wrist-wearable device 1902, AR glasses 1904, and/or HIPD 1906 to manipulate the image capture (e.g., zoom in or out, apply filters, etc.) and capture image data.

Users may interact with the devices disclosed herein in a variety of ways. For example, as shown in FIGS. 20A and 20B, a user 2008 may interact with an AR system 2000 by donning a VR headset 2050 while holding HIPD 2006 and wearing wrist-wearable device 2002. In this example, AR system 2000 may enable a user to interact with a game 2010 by swiping their arm. One or more of VR headset 2050, HIPD 2006, and wrist-wearable device 2002 may detect this gesture and, in response, may display a sword strike in game 2010. Similarly, in FIGS. 21A and 21B, a user 2108 may interact with an AR system 2100 by donning a VR headset 2120 while wearing haptic device 2160 and wrist-wearable device 2130. In this example, AR system 2100 may enable a user to interact with a game 2110 by swiping their arm. One or more of VR headset 2120, haptic device 2160, and wrist-wearable device 2130 may detect this gesture and, in response, may display a spell being cast in game 2010.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiography (ECG or EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configured to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 2402.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 22 and 23 illustrate an example wrist-wearable device 2200 and an example computer system 2300, in accordance with some embodiments. Wrist-wearable device 2200 is an instance of wearable device 1802 described in FIG. 18 herein, such that the wearable device 1802 should be understood to have the features of the wrist-wearable device 2200 and vice versa. FIG. 23 illustrates components of the wrist-wearable device 2200, which can be used individually or in combination, including combinations that include other electronic devices and/or electronic components.

FIG. 22 shows a wearable band 2210 and a watch body 2220 (or capsule) being coupled, as discussed below, to form wrist-wearable device 2200. Wrist-wearable device 2200 can perform various functions and/or operations associated with navigating through user interfaces and selectively opening applications as well as the functions and/or operations described above with reference to FIGS. 18-21B.

As will be described in more detail below, operations executed by wrist-wearable device 2200 can include (i) presenting content to a user (e.g., displaying visual content via a display 2205), (ii) detecting (e.g., sensing) user input (e.g., sensing a touch on peripheral button 2223 and/or at a touch screen of the display 2205, a hand gesture detected by sensors (e.g., biopotential sensors)), (iii) sensing biometric data (e.g., neuromuscular signals, heart rate, temperature, sleep, etc.) via one or more sensors 2213, messaging (e.g., text, speech, video, etc.); image capture via one or more imaging devices or cameras 2225, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 2220, independently in wearable band 2210, and/or via an electronic communication between watch body 2220 and wearable band 2210. In some embodiments, functions can be executed on wrist-wearable device 2200 while an AR environment is being presented (e.g., via one of AR systems 1800 to 2100). The wearable devices described herein can also be used with other types of AR environments.

Wearable band 2210 can be configured to be worn by a user such that an inner surface of a wearable structure 2211 of wearable band 2210 is in contact with the user's skin. In this example, when worn by a user, sensors 2213 may contact the user's skin. In some examples, one or more of sensors 2213 can sense biometric data such as a user's heart rate, a saturated oxygen level, temperature, sweat level, neuromuscular signals, or a combination thereof. One or more of sensors 2213 can also sense data about a user's environment including a user's motion, altitude, location, orientation, gait, acceleration, position, or a combination thereof. In some embodiment, one or more of sensors 2213 can be configured to track a position and/or motion of wearable band 2210. One or more of sensors 2213 can include any of the sensors defined above and/or discussed below with respect to FIG. 22.

One or more of sensors 2213 can be distributed on an inside and/or an outside surface of wearable band 2210. In some embodiments, one or more of sensors 2213 are uniformly spaced along wearable band 2210. Alternatively, in some embodiments, one or more of sensors 2213 are positioned at distinct points along wearable band 2210. As shown in FIG. 22, one or more of sensors 2213 can be the same or distinct. For example, in some embodiments, one or more of sensors 2213 can be shaped as a pill (e.g., sensor 2213a), an oval, a circle a square, an oblong (e.g., sensor 2213c) and/or any other shape that maintains contact with the user's skin (e.g., such that neuromuscular signal and/or other biometric data can be accurately measured at the user's skin). In some embodiments, one or more sensors of 2213 are aligned to form pairs of sensors (e.g., for sensing neuromuscular signals based on differential sensing within each respective sensor). For example, sensor 2213b may be aligned with an adjacent sensor to form sensor pair 2214a and sensor 2213d may be aligned with an adjacent sensor to form sensor pair 2214b. In some embodiments, wearable band 2210 does not have a sensor pair. Alternatively, in some embodiments, wearable band 2210 has a predetermined number of sensor pairs (one pair of sensors, three pairs of sensors, four pairs of sensors, six pairs of sensors, sixteen pairs of sensors, etc.).

Wearable band 2210 can include any suitable number of sensors 2213. In some embodiments, the number and arrangement of sensors 2213 depends on the particular application for which wearable band 2210 is used. For instance, wearable band 2210 can be configured as an armband, wristband, or chest-band that include a plurality of sensors 2213 with different number of sensors 2213, a variety of types of individual sensors with the plurality of sensors 2213, and different arrangements for each use case, such as medical use cases as compared to gaming or general day-to-day use cases.

In accordance with some embodiments, wearable band 2210 further includes an electrical ground electrode and a shielding electrode. The electrical ground and shielding electrodes, like the sensors 2213, can be distributed on the inside surface of the wearable band 2210 such that they contact a portion of the user's skin. For example, the electrical ground and shielding electrodes can be at an inside surface of a coupling mechanism 2216 or an inside surface of a wearable structure 2211. The electrical ground and shielding electrodes can be formed and/or use the same components as sensors 2213. In some embodiments, wearable band 2210 includes more than one electrical ground electrode and more than one shielding electrode.

Sensors 2213 can be formed as part of wearable structure 2211 of wearable band 2210. In some embodiments, sensors 2213 are flush or substantially flush with wearable structure 2211 such that they do not extend beyond the surface of wearable structure 2211. While flush with wearable structure 2211, sensors 2213 are still configured to contact the user's skin (e.g., via a skin-contacting surface). Alternatively, in some embodiments, sensors 2213 extend beyond wearable structure 2211 a predetermined distance (e.g., 0.1-2 mm) to make contact and depress into the user's skin. In some embodiment, sensors 2213 are coupled to an actuator (not shown) configured to adjust an extension height (e.g., a distance from the surface of wearable structure 2211) of sensors 2213 such that sensors 2213 make contact and depress into the user's skin. In some embodiments, the actuators adjust the extension height between 0.01 mm-1.2 mm. This may allow a the user to customize the positioning of sensors 2213 to improve the overall comfort of the wearable band 2210 when worn while still allowing sensors 2213 to contact the user's skin. In some embodiments, sensors 2213 are indistinguishable from wearable structure 2211 when worn by the user.

Wearable structure 2211 can be formed of an elastic material, elastomers, etc., configured to be stretched and fitted to be worn by the user. In some embodiments, wearable structure 2211 is a textile or woven fabric. As described above, sensors 2213 can be formed as part of a wearable structure 2211. For example, sensors 2213 can be molded into the wearable structure 2211, be integrated into a woven fabric (e.g., sensors 2213 can be sewn into the fabric and mimic the pliability of fabric and can and/or be constructed from a series woven strands of fabric).

Wearable structure 2211 can include flexible electronic connectors that interconnect sensors 2213, the electronic circuitry, and/or other electronic components (described below in reference to FIG. 23) that are enclosed in wearable band 2210. In some embodiments, the flexible electronic connectors are configured to interconnect sensors 2213, the electronic circuitry, and/or other electronic components of wearable band 2210 with respective sensors and/or other electronic components of another electronic device (e.g., watch body 2220). The flexible electronic connectors are configured to move with wearable structure 2211 such that the user adjustment to wearable structure 2211 (e.g., resizing, pulling, folding, etc.) does not stress or strain the electrical coupling of components of wearable band 2210.

As described above, wearable band 2210 is configured to be worn by a user. In particular, wearable band 2210 can be shaped or otherwise manipulated to be worn by a user. For example, wearable band 2210 can be shaped to have a substantially circular shape such that it can be configured to be worn on the user's lower arm or wrist. Alternatively, wearable band 2210 can be shaped to be worn on another body part of the user, such as the user's upper arm (e.g., around a bicep), forearm, chest, legs, etc. Wearable band 2210 can include a retaining mechanism 2212 (e.g., a buckle, a hook and loop fastener, etc.) for securing wearable band 2210 to the user's wrist or other body part. While wearable band 2210 is worn by the user, sensors 2213 sense data (referred to as sensor data) from the user's skin. In some examples, sensors 2213 of wearable band 2210 obtain (e.g., sense and record) neuromuscular signals.

The sensed data (e.g., sensed neuromuscular signals) can be used to detect and/or determine the user's intention to perform certain motor actions. In some examples, sensors 2213 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 2205 of wrist-wearable device 2200 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 2213 can be used to provide a user with an enhanced interaction with a physical object (e.g., devices communicatively coupled with wearable band 2210) and/or a virtual object in an artificial-reality application generated by an artificial-reality system (e.g., user interface objects presented on the display 2205, or another computing device (e.g., a smartphone)).

In some embodiments, wearable band 2210 includes one or more haptic devices 2346 (e.g., a vibratory haptic actuator) that are configured to provide haptic feedback (e.g., a cutaneous and/or kinesthetic sensation, etc.) to the user's skin. Sensors 2213 and/or haptic devices 2346 (shown in FIG. 23) can be configured to operate in conjunction with multiple applications including, without limitation, health monitoring, social media, games, and artificial reality (e.g., the applications associated with artificial reality).

Wearable band 2210 can also include coupling mechanism 2216 for detachably coupling a capsule (e.g., a computing unit) or watch body 2220 (via a coupling surface of the watch body 2220) to wearable band 2210. For example, a cradle or a shape of coupling mechanism 2216 can correspond to shape of watch body 2220 of wrist-wearable device 2200. In particular, coupling mechanism 2216 can be configured to receive a coupling surface proximate to the bottom side of watch body 2220 (e.g., a side opposite to a front side of watch body 2220 where display 2205 is located), such that a user can push watch body 2220 downward into coupling mechanism 2216 to attach watch body 2220 to coupling mechanism 2216. In some embodiments, coupling mechanism 2216 can be configured to receive a top side of the watch body 2220 (e.g., a side proximate to the front side of watch body 2220 where display 2205 is located) that is pushed upward into the cradle, as opposed to being pushed downward into coupling mechanism 2216. In some embodiments, coupling mechanism 2216 is an integrated component of wearable band 2210 such that wearable band 2210 and coupling mechanism 2216 are a single unitary structure. In some embodiments, coupling mechanism 2216 is a type of frame or shell that allows watch body 2220 coupling surface to be retained within or on wearable band 2210 coupling mechanism 2216 (e.g., a cradle, a tracker band, a support base, a clasp, etc.).

Coupling mechanism 2216 can allow for watch body 2220 to be detachably coupled to the wearable band 2210 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 2220 to wearable band 2210 and to decouple the watch body 2220 from the wearable band 2210. For example, a user can twist, slide, turn, push, pull, or rotate watch body 2220 relative to wearable band 2210, or a combination thereof, to attach watch body 2220 to wearable band 2210 and to detach watch body 2220 from wearable band 2210. Alternatively, as discussed below, in some embodiments, the watch body 2220 can be decoupled from the wearable band 2210 by actuation of a release mechanism 2229.

Wearable band 2210 can be coupled with watch body 2220 to increase the functionality of wearable band 2210 (e.g., converting wearable band 2210 into wrist-wearable device 2200, adding an additional computing unit and/or battery to increase computational resources and/or a battery life of wearable band 2210, adding additional sensors to improve sensed data, etc.). As described above, wearable band 2210 and coupling mechanism 2216 are configured to operate independently (e.g., execute functions independently) from watch body 2220. For example, coupling mechanism 2216 can include one or more sensors 2213 that contact a user's skin when wearable band 2210 is worn by the user, with or without watch body 2220 and can provide sensor data for determining control commands.

A user can detach watch body 2220 from wearable band 2210 to reduce the encumbrance of wrist-wearable device 2200 to the user. For embodiments in which watch body 2220 is removable, watch body 2220 can be referred to as a removable structure, such that in these embodiments wrist-wearable device 2200 includes a wearable portion (e.g., wearable band 2210) and a removable structure (e.g., watch body 2220).

Turning to watch body 2220, in some examples watch body 2220 can have a substantially rectangular or circular shape. Watch body 2220 is configured to be worn by the user on their wrist or on another body part. More specifically, watch body 2220 is sized to be easily carried by the user, attached on a portion of the user's clothing, and/or coupled to wearable band 2210 (forming the wrist-wearable device 2200). As described above, watch body 2220 can have a shape corresponding to coupling mechanism 2216 of wearable band 2210. In some embodiments, watch body 2220 includes a single release mechanism 2229 or multiple release mechanisms (e.g., two release mechanisms 2229 positioned on opposing sides of watch body 2220, such as spring-loaded buttons) for decoupling watch body 2220 from wearable band 2210. Release mechanism 2229 can include, without limitation, a button, a knob, a plunger, a handle, a lever, a fastener, a clasp, a dial, a latch, or a combination thereof.

A user can actuate release mechanism 2229 by pushing, turning, lifting, depressing, shifting, or performing other actions on release mechanism 2229. Actuation of release mechanism 2229 can release (e.g., decouple) watch body 2220 from coupling mechanism 2216 of wearable band 2210, allowing the user to use watch body 2220 independently from wearable band 2210 and vice versa. For example, decoupling watch body 2220 from wearable band 2210 can allow a user to capture images using rear-facing camera 2225b. Although release mechanism 2229 is shown positioned at a corner of watch body 2220, release mechanism 2229 can be positioned anywhere on watch body 2220 that is convenient for the user to actuate. In addition, in some embodiments, wearable band 2210 can also include a respective release mechanism for decoupling watch body 2220 from coupling mechanism 2216. In some embodiments, release mechanism 2229 is optional and watch body 2220 can be decoupled from coupling mechanism 2216 as described above (e.g., via twisting, rotating, etc.).

Watch body 2220 can include one or more peripheral buttons 2223 and 2227 for performing various operations at watch body 2220. For example, peripheral buttons 2223 and 2227 can be used to turn on or wake (e.g., transition from a sleep state to an active state) display 2205, unlock watch body 2220, increase or decrease a volume, increase or decrease a brightness, interact with one or more applications, interact with one or more user interfaces, etc. Additionally or alternatively, in some embodiments, display 2205 operates as a touch screen and allows the user to provide one or more inputs for interacting with watch body 2220.

In some embodiments, watch body 2220 includes one or more sensors 2221. Sensors 2221 of watch body 2220 can be the same or distinct from sensors 2213 of wearable band 2210. Sensors 2221 of watch body 2220 can be distributed on an inside and/or an outside surface of watch body 2220. In some embodiments, sensors 2221 are configured to contact a user's skin when watch body 2220 is worn by the user. For example, sensors 2221 can be placed on the bottom side of watch body 2220 and coupling mechanism 2216 can be a cradle with an opening that allows the bottom side of watch body 2220 to directly contact the user's skin. Alternatively, in some embodiments, watch body 2220 does not include sensors that are configured to contact the user's skin (e.g., including sensors internal and/or external to the watch body 2220 that are configured to sense data of watch body 2220 and the surrounding environment). In some embodiments, sensors 2221 are configured to track a position and/or motion of watch body 2220.

Watch body 2220 and wearable band 2210 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 2220 and wearable band 2210 can share data sensed by sensors 2213 and 2221, as well as application and device specific information (e.g., active and/or available applications, output devices (e.g., displays, speakers, etc.), input devices (e.g., touch screens, microphones, imaging sensors, etc.).

In some embodiments, watch body 2220 can include, without limitation, a front-facing camera 2225a and/or a rear-facing camera 2225b, sensors 2221 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 2363), a touch sensor, a sweat sensor, etc.). In some embodiments, watch body 2220 can include one or more haptic devices 2376 (e.g., a vibratory haptic actuator) that is configured to provide haptic feedback (e.g., a cutaneous and/or kinesthetic sensation, etc.) to the user. Sensors 2321 and/or haptic device 2376 can also be configured to operate in conjunction with multiple applications including, without limitation, health monitoring applications, social media applications, game applications, and artificial reality applications (e.g., the applications associated with artificial reality).

As described above, watch body 2220 and wearable band 2210, when coupled, can form wrist-wearable device 2200. When coupled, watch body 2220 and wearable band 2210 may operate as a single device to execute functions (operations, detections, communications, etc.) described herein. In some embodiments, each device may be provided with particular instructions for performing the one or more operations of wrist-wearable device 2200. For example, in accordance with a determination that watch body 2220 does not include neuromuscular signal sensors, wearable band 2210 can include alternative instructions for performing associated instructions (e.g., providing sensed neuromuscular signal data to watch body 2220 via a different electronic device). Operations of wrist-wearable device 2200 can be performed by watch body 2220 alone or in conjunction with wearable band 2210 (e.g., via respective processors and/or hardware components) and vice versa. In some embodiments, operations of wrist-wearable device 2200, watch body 2220, and/or wearable band 2210 can be performed in conjunction with one or more processors and/or hardware components.

As described below with reference to the block diagram of FIG. 23, wearable band 2210 and/or watch body 2220 can each include independent resources required to independently execute functions. For example, wearable band 2210 and/orwatch body 2220 can each include a power source (e.g., a battery), a memory, data storage, a processor (e.g., a central processing unit (CPU)), communications, a light source, and/or input/output devices.

FIG. 23 shows block diagrams of a computing system 2330 corresponding to wearable band 2210 and a computing system 2360 corresponding to watch body 2220 according to some embodiments. Computing system 2300 of wrist-wearable device 2200 may include a combination of components of wearable band computing system 2330 and watch body computing system 2360, in accordance with some embodiments.

Watch body 2220 and/or wearable band 2210 can include one or more components shown in watch body computing system 2360. In some embodiments, a single integrated circuit may include all or a substantial portion of the components of watch body computing system 2360 included in a single integrated circuit. Alternatively, in some embodiments, components of the watch body computing system 2360 may be included in a plurality of integrated circuits that are communicatively coupled. In some embodiments, watch body computing system 2360 may be configured to couple (e.g., via a wired or wireless connection) with wearable band computing system 2330, which may allow the computing systems to share components, distribute tasks, and/or perform other operations described herein (individually or as a single device).

Watch body computing system 2360 can include one or more processors 2379, a controller 2377, a peripherals interface 2361, a power system 2395, and memory (e.g., a memory 2380).

Power system 2395 can include a charger input 2396, a power-management integrated circuit (PMIC) 2397, and a battery 2398. In some embodiments, a watch body 2220 and a wearable band 2210 can have respective batteries (e.g., battery 2398 and 2359) and can share power with each other. Watch body 2220 and wearable band 2210 can receive a charge using a variety of techniques. In some embodiments, watch body 2220 and wearable band 2210 can use a wired charging assembly (e.g., power cords) to receive the charge. Alternatively, or in addition, watch body 2220 and/or wearable band 2210 can be configured for wireless charging. For example, a portable charging device can be designed to mate with a portion of watch body 2220 and/or wearable band 2210 and wirelessly deliver usable power to battery 2398 of watch body 2220 and/or battery 2359 of wearable band 2210. Watch body 2220 and wearable band 2210 can have independent power systems (e.g., power system 2395 and 2356, respectively) to enable each to operate independently. Watch body 2220 and wearable band 2210 can also share power (e.g., one can charge the other) via respective PMICs (e.g., PMICs 2397 and 2358) and charger inputs (e.g., 2357 and 2396) that can share power over power and ground conductors and/or over wireless charging antennas.

In some embodiments, peripherals interface 2361 can include one or more sensors 2321. Sensors 2321 can include one or more coupling sensors 2362 for detecting when watch body 2220 is coupled with another electronic device (e.g., a wearable band 2210). Sensors 2321 can include one or more imaging sensors 2363 (e.g., one or more of cameras 2325, and/or separate imaging sensors 2363 (e.g., thermal-imaging sensors)). In some embodiments, sensors 2321 can include one or more SpO2 sensors 2364. In some embodiments, sensors 2321 can include one or more biopotential-signal sensors (e.g., EMG sensors 2365, which may be disposed on an interior, user-facing portion of watch body 2220 and/or wearable band 2210). In some embodiments, sensors 2321 may include one or more capacitive sensors 2366. In some embodiments, sensors 2321 may include one or more heart rate sensors 2367. In some embodiments, sensors 2321 may include one or more IMU sensors 2368. In some embodiments, one or more IMU sensors 2368 can be configured to detect movement of a user's hand or other location where watch body 2220 is placed or held.

In some embodiments, one or more of sensors 2321 may provide an example human-machine interface. For example, a set of neuromuscular sensors, such as EMG sensors 2365, may be arranged circumferentially around wearable band 2210 with an interior surface of EMG sensors 2365 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 2210 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 2379. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 2365 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 2361 includes a near-field communication (NFC) component 2369, a global-position system (GPS) component 2370, a long-term evolution (LTE) component 2371, and/or a Wi-Fi and/or Bluetooth communication component 2372. In some embodiments, peripherals interface 2361 includes one or more buttons 2373 (e.g., peripheral buttons 2223 and 2227 in FIG. 22), which, when selected by a user, cause operation to be performed at watch body 2220. In some embodiments, the peripherals interface 2361 includes one or more indicators, such as a light emitting diode (LED), to provide a user with visual indicators (e.g., message received, low battery, active microphone and/or camera, etc.).

Watch body 2220 can include at least one display 2205 for displaying visual representations of information or data to a user, including user-interface elements and/or three-dimensional virtual objects. The display can also include a touch screen for inputting user inputs, such as touch gestures, swipe gestures, and the like. Watch body 2220 can include at least one speaker 2374 and at least one microphone 2375 for providing audio signals to the user and receiving audio input from the user. The user can provide user inputs through microphone 2375 and can also receive audio output from speaker 2374 as part of a haptic event provided by haptic controller 2378. Watch body 2220 can include at least one camera 2325, including a front camera 2325a and a rear camera 2325b. Cameras 2325 can include ultra-wide-angle cameras, wide angle cameras, fish-eye cameras, spherical cameras, telephoto cameras, depth-sensing cameras, or other types of cameras.

Watch body computing system 2360 can include one or more haptic controllers 2378 and associated componentry (e.g., haptic devices 2376) for providing haptic events at watch body 2220 (e.g., a vibrating sensation or audio output in response to an event at the watch body 2220). Haptic controllers 2378 can communicate with one or more haptic devices 2376, such as electroacoustic devices, including a speaker of the one or more speakers 2374 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 2378 can provide haptic events to that are capable of being sensed by a user of watch body 2220. In some embodiments, one or more haptic controllers 2378 can receive input signals from an application of applications 2382.

In some embodiments, wearable band computing system 2330 and/or watch body computing system 2360 can include memory 2380, which can be controlled by one or more memory controllers of controllers 2377. In some embodiments, software components stored in memory 2380 include one or more applications 2382 configured to perform operations at the watch body 2220. In some embodiments, one or more applications 2382 may include games, word processors, messaging applications, calling applications, web browsers, social media applications, media streaming applications, financial applications, calendars, clocks, etc. In some embodiments, software components stored in memory 2380 include one or more communication interface modules 2383 as defined above. In some embodiments, software components stored in memory 2380 include one or more graphics modules 2384 for rendering, encoding, and/or decoding audio and/or visual data and one or more data management modules 2385 for collecting, organizing, and/or providing access to data 2387 stored in memory 2380. In some embodiments, one or more of applications 2382 and/or one or more modules can work in conjunction with one another to perform various tasks at the watch body 2220.

In some embodiments, software components stored in memory 2380 can include one or more operating systems 2381 (e.g., a Linux-based operating system, an Android operating system, etc.). Memory 2380 can also include data 2387. Data 2387 can include profile data 2388A, sensor data 2389A, media content data 2390, and application data 2391.

It should be appreciated that watch body computing system 2360 is an example of a computing system within watch body 2220, and that watch body 2220 can have more or fewer components than shown in watch body computing system 2360, can combine two or more components, and/or can have a different configuration and/or arrangement of the components. The various components shown in watch body computing system 2360 are implemented in hardware, software, firmware, or a combination thereof, including one or more signal processing and/or application-specific integrated circuits.

Turning to the wearable band computing system 2330, one or more components that can be included in wearable band 2210 are shown. Wearable band computing system 2330 can include more or fewer components than shown in watch body computing system 2360, can combine two or more components, and/or can have a different configuration and/or arrangement of some orall of the components. In some embodiments, all, ora substantial portion of the components of wearable band computing system 2330 are included in a single integrated circuit. Alternatively, in some embodiments, components of wearable band computing system 2330 are included in a plurality of integrated circuits that are communicatively coupled. As described above, in some embodiments, wearable band computing system 2330 is configured to couple (e.g., via a wired or wireless connection) with watch body computing system 2360, which allows the computing systems to share components, distribute tasks, and/or perform other operations described herein (individually or as a single device).

Wearable band computing system 2330, similar to watch body computing system 2360, can include one or more processors 2349, one or more controllers 2347 (including one or more haptics controllers 2348), a peripherals interface 2331 that can includes one or more sensors 2313 and other peripheral devices, a power source (e.g., a power system 2356), and memory (e.g., a memory 2350) that includes an operating system (e.g., an operating system 2351), data (e.g., data 2354 including profile data 2388B, sensor data 2389B, etc.), and one or more modules (e.g., a communications interface module 2352, a data management module 2353, etc.).

One or more of sensors 2313 can be analogous to sensors 2321 of watch body computing system 2360. For example, sensors 2313 can include one or more coupling sensors 2332, one or more SpO2 sensors 2334, one or more EMG sensors 2335, one or more capacitive sensors 2336, one or more heart rate sensors 2337, and one or more IMU sensors 2338.

Peripherals interface 2331 can also include other components analogous to those included in peripherals interface 2361 of watch body computing system 2360, including an NFC component 2339, a GPS component 2340, an LTE component 2341, a Wi-Fi and/or Bluetooth communication component 2342, and/or one or more haptic devices 2346 as described above in reference to peripherals interface 2361. In some embodiments, peripherals interface 2331 includes one or more buttons 2343, a display 2333, a speaker 2344, a microphone 2345, and a camera 2355. In some embodiments, peripherals interface 2331 includes one or more indicators, such as an LED.

It should be appreciated that wearable band computing system 2330 is an example of a computing system within wearable band 2210, and that wearable band 2210 can have more or fewer components than shown in wearable band computing system 2330, combine two or more components, and/or have a different configuration and/or arrangement of the components. The various components shown in wearable band computing system 2330 can be implemented in one or more of a combination of hardware, software, or firmware, including one or more signal processing and/or application-specific integrated circuits.

Wrist-wearable device 2200 with respect to FIG. 22 is an example of wearable band 2210 and watch body 2220 coupled together, so wrist-wearable device 2200 will be understood to include the components shown and described for wearable band computing system 2330 and watch body computing system 2360. In some embodiments, wrist-wearable device 2200 has a split architecture (e.g., a split mechanical architecture, a split electrical architecture, etc.) between watch body 2220 and wearable band 2210. In other words, all of the components shown in wearable band computing system 2330 and watch body computing system 2360 can be housed or otherwise disposed in a combined wrist-wearable device 2200 or within individual components of watch body 2220, wearable band 2210, and/or portions thereof (e.g., a coupling mechanism 2216 of wearable band 2210).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 2200 can be used in conjunction with a head-wearable device (e.g., AR glasses 2400 and VR system 2510) and/or an HIPD, and wrist-wearable device 2200 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR glasses 2400 and VR headset 2510.

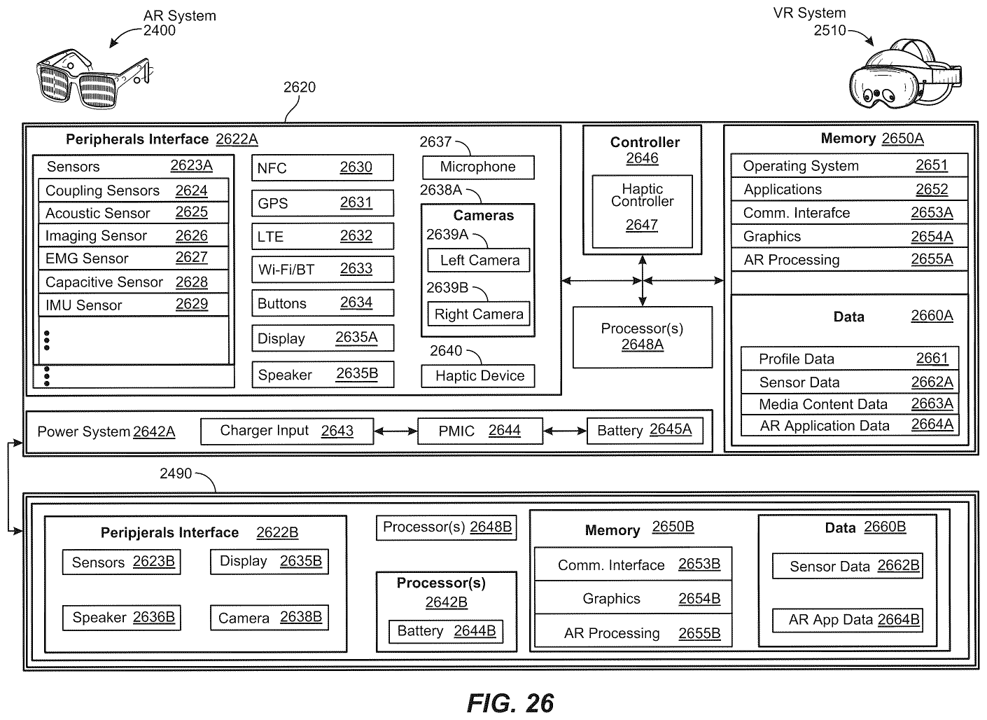

FIGS. 24 to 26 show example artificial-reality systems, which can be used as or in connection with wrist-wearable device 2200. In some embodiments, AR system 2400 includes an eyewear device 2402, as shown in FIG. 24. In some embodiments, VR system 2510 includes a head-mounted display (HMD) 2512, as shown in FIGS. 25A and 25B. In some embodiments, AR system 2400 and VR system 2510 can include one or more analogous components (e.g., components for presenting interactive artificial-reality environments, such as processors, memory, and/or presentation devices, including one or more displays and/or one or more waveguides), some of which are described in more detail with respect to FIG. 26. As described herein, a head-wearable device can include components of eyewear device 2402 and/or head-mounted display 2512. Some embodiments of head-wearable devices do not include any displays, including any of the displays described with respect to AR system 2400 and/or VR system 2510. While the example artificial-reality systems are respectively described herein as AR system 2400 and VR system 2510, either or both of the example AR systems described herein can be configured to present fully-immersive virtual-reality scenes presented in substantially all of a user's field of view or subtler augmented-reality scenes that are presented within a portion, less than all, of the user's field of view.

FIG. 24 show an example visual depiction of AR system 2400, including an eyewear device 2402 (which may also be described herein as augmented-reality glasses, and/or smart glasses). AR system 2400 can include additional electronic components that are not shown in FIG. 24, such as a wearable accessory device and/or an intermediary processing device, in electronic communication or otherwise configured to be used in conjunction with the eyewear device 2402. In some embodiments, the wearable accessory device and/or the intermediary processing device may be configured to couple with eyewear device 2402 via a coupling mechanism in electronic communication with a coupling sensor 2624 (FIG. 26), where coupling sensor 2624 can detect when an electronic device becomes physically or electronically coupled with eyewear device 2402. In some embodiments, eyewear device 2402 can be configured to couple to a housing 2690 (FIG. 26), which may include one or more additional coupling mechanisms configured to couple with additional accessory devices. The components shown in FIG. 24 can be implemented in hardware, software, firmware, or a combination thereof, including one or more signal-processing components and/or application-specific integrated circuits (ASICs).

Eyewear device 2402 includes mechanical glasses components, including a frame 2404 configured to hold one or more lenses (e.g., one or both lenses 2406-1 and 2406-2). One of ordinary skill in the art will appreciate that eyewear device 2402 can include additional mechanical components, such as hinges configured to allow portions of frame 2404 of eyewear device 2402 to be folded and unfolded, a bridge configured to span the gap between lenses 2406-1 and 2406-2 and rest on the user's nose, nose pads configured to rest on the bridge of the nose and provide support for eyewear device 2402, earpieces configured to rest on the user's ears and provide additional support for eyewear device 2402, temple arms configured to extend from the hinges to the earpieces of eyewear device 2402, and the like. One of ordinary skill in the art will further appreciate that some examples of AR system 2400 can include none of the mechanical components described herein. For example, smart contact lenses configured to present artificial reality to users may not include any components of eyewear device 2402.

Eyewear device 2402 includes electronic components, many of which will be described in more detail below with respect to FIG. 26. Some example electronic components are illustrated in FIG. 24, including acoustic sensors 2425-1, 2425-2, 2425-3, 2425-4, 2425-5, and 2425-6, which can be distributed along a substantial portion of the frame 2404 of eyewear device 2402. Eyewear device 2402 also includes a left camera 2439A and a right camera 2439B, which are located on different sides of the frame 2404. Eyewear device 2402 also includes a processor 2448 (or any other suitable type or form of integrated circuit) that is embedded into a portion of the frame 2404.

FIGS. 25A and 25B show a VR system 2510 that includes a head-mounted display (HMD) 2512 (e.g., also referred to herein as an artificial-reality headset, a head-wearable device, a VR headset, etc.), in accordance with some embodiments. As noted, some artificial-reality systems (e.g., AR system 2400) may, instead of blending an artificial reality with actual reality, substantially replace one or more of a user's visual and/or other sensory perceptions of the real world with a virtual experience (e.g., AR systems 2000 and 2100).

HMD 2512 includes a front body 2514 and a frame 2516 (e.g., a strap or band) shaped to fit around a user's head. In some embodiments, front body 2514 and/or frame 2516 include one or more electronic elements for facilitating presentation of and/or interactions with an AR and/or VR system (e.g., displays, IMUs, tracking emitter or detectors). In some embodiments, HMD 2512 includes output audio transducers (e.g., an audio transducer 2518), as shown in FIG. 25B. In some embodiments, one or more components, such as the output audio transducer(s) 2518 and frame 2516, can be configured to attach and detach (e.g., are detachably attachable) to HMD 2512 (e.g., a portion or all of frame 2516, and/or audio transducer 2518), as shown in FIG. 25B. In some embodiments, coupling a detachable component to HMD 2512 causes the detachable component to come into electronic communication with HMD 2512.

FIGS. 25A and 25B also show that VR system 2510 includes one or more cameras, such as left camera 2539A and right camera 2539B, which can be analogous to left and right cameras 2439A and 2439B on frame 2404 of eyewear device 2402. In some embodiments, VR system 2510 includes one or more additional cameras (e.g., cameras 2539C and 2539D), which can be configured to augment image data obtained by left and right cameras 2539A and 2539B by providing more information. For example, camera 2539C can be used to supply color information that is not discerned by cameras 2539A and 2539B. In some embodiments, one or more of cameras 2539A to 2539D can include an optional IR cut filter configured to remove IR light from being received at the respective camera sensors.

FIG. 26 illustrates a computing system 2620 and an optional housing 2690, each of which show components that can be included in AR system 2400 and/or VR system 2510. In some embodiments, more or fewer components can be included in optional housing 2690 depending on practical restraints of the respective AR system being described.

In some embodiments, computing system 2620 can include one or more peripherals interfaces 2622A and/or optional housing 2690 can include one or more peripherals interfaces 2622B. Each of computing system 2620 and optional housing 2690 can also include one or more power systems 2642A and 2642B, one or more controllers 2646 (including one or more haptic controllers 2647), one or more processors 2648A and 2648B (as defined above, including any of the examples provided), and memory 2650A and 2650B, which can all be in electronic communication with each other. For example, the one or more processors 2648A and 2648B can be configured to execute instructions stored in memory 2650A and 2650B, which can cause a controller of one or more of controllers 2646 to cause operations to be performed at one or more peripheral devices connected to peripherals interface 2622A and/or 2622B. In some embodiments, each operation described can be powered by electrical power provided by power system 2642A and/or 2642B.

In some embodiments, peripherals interface 2622A can include one or more devices configured to be part of computing system 2620, some of which have been defined above and/or described with respect to the wrist-wearable devices shown in FIGS. 22 and 23. For example, peripherals interface 2622A can include one or more sensors 2623A. Some example sensors 2623A include one or more coupling sensors 2624, one or more acoustic sensors 2625, one or more imaging sensors 2626, one or more EMG sensors 2627, one or more capacitive sensors 2628, one or more IMU sensors 2629, and/or any other types of sensors explained above or described with respect to any other embodiments discussed herein.

In some embodiments, peripherals interfaces 2622A and 2622B can include one or more additional peripheral devices, including one or more NFC devices 2630, one or more GPS devices 2631, one or more LTE devices 2632, one or more Wi-Fi and/or Bluetooth devices 2633, one or more buttons 2634 (e.g., including buttons that are slidable or otherwise adjustable), one or more displays 2635A and 2635B, one or more speakers 2636A and 2636B, one or more microphones 2637, one or more cameras 2638A and 2638B (e.g., including the left camera 2639A and/or a right camera 2639B), one or more haptic devices 2640, and/or any other types of peripheral devices defined above or described with respect to any other embodiments discussed herein.

AR systems can include a variety of types of visual feedback mechanisms (e.g., presentation devices). For example, display devices in AR system 2400 and/or VR system 2510 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 2635A and 2635B can be coupled to each of the lenses 2406-1 and 2406-2 of AR system 2400. Displays 2635A and 2635B may be coupled to each of lenses 2406-1 and 2406-2, which can act together or independently to present an image or series of images to a user. In some embodiments, AR system 2400 includes a single display 2635A or 2635B (e.g., a near-eye display) or more than two displays 2635A and 2635B. In some embodiments, a first set of one or more displays 2635A and 2635B can be used to present an augmented-reality environment, and a second set of one or more display devices 2635A and 2635B can be used to present a virtual-reality environment. In some embodiments, one or more waveguides are used in conjunction with presenting artificial-reality content to the user of AR system 2400 (e.g., as a means of delivering light from one or more displays 2635A and 2635B to the user's eyes). In some embodiments, one or more waveguides are fully or partially integrated into the eyewear device 2402. Additionally, or alternatively to display screens, some artificial-reality systems include one or more projection systems. For example, display devices in AR system 2400 and/or VR system 2510 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 2635A and 2635B.

Computing system 2620 and/or optional housing 2690 of AR system 2400 or VR system 2510 can include some or all of the components of a power system 2642A and 2642B. Power systems 2642A and 2642B can include one or more charger inputs 2643, one or more PMICs 2644, and/or one or more batteries 2645A and 2644B.

Memory 2650A and 2650B may include instructions and data, some or all of which may be stored as non-transitory computer-readable storage media within the memories 2650A and 2650B. For example, memory 2650A and 2650B can include one or more operating systems 2651, one or more applications 2652, one or more communication interface applications 2653A and 2653B, one or more graphics applications 2654A and 2654B, one or more AR processing applications 2655A and 2655B, and/or any other types of data defined above or described with respect to any other embodiments discussed herein.

Memory 2650A and 2650B also include data 2660A and 2660B, which can be used in conjunction with one or more of the applications discussed above. Data 2660A and 2660B can include profile data 2661, sensor data 2662A and 2662B, media content data 2663A, AR application data 2664A and 2664B, and/or any other types of data defined above or described with respect to any other embodiments discussed herein.

In some embodiments, controller 2646 of eyewear device 2402 may process information generated by sensors 2623A and/or 2623B on eyewear device 2402 and/or another electronic device within AR system 2400. For example, controller 2646 can process information from acoustic sensors 2425-1 and 2425-2. For each detected sound, controller 2646 can perform a direction of arrival (DOA) estimation to estimate a direction from which the detected sound arrived at eyewear device 2402 of AR system 2400. As one or more of acoustic sensors 2625 (e.g., the acoustic sensors 2425-1, 2425-2) detects sounds, controller 2646 can populate an audio data set with the information (e.g., represented in FIG. 26 as sensor data 2662A and 2662B).

In some embodiments, a physical electronic connector can convey information between eyewear device 2402 and another electronic device and/or between one or more processors 2448, 2648A, 2648B of AR system 2400 or VR system 2510 and controller 2646. The information can be in the form of optical data, electrical data, wireless data, or any other transmittable data form. Moving the processing of information generated by eyewear device 2402 to an intermediary processing device can reduce weight and heat in the eyewear device, making it more comfortable and safer for a user. In some embodiments, an optional wearable accessory device (e.g., an electronic neckband) is coupled to eyewear device 2402 via one or more connectors. The connectors can be wired or wireless connectors and can include electrical and/or non-electrical (e.g., structural) components. In some embodiments, eyewear device 2402 and the wearable accessory device can operate independently without any wired or wireless connection between them.

In some situations, pairing external devices, such as an intermediary processing device (e.g., HIPD 1806, 1906, 2006) with eyewear device 2402 (e.g., as part of AR system 2400) enables eyewear device 2402 to achieve a similar form factor of a pair of glasses while still providing sufficient battery and computation power for expanded capabilities. Some, or all, of the battery power, computational resources, and/or additional features of AR system 2400 can be provided by a paired device or shared between a paired device and eyewear device 2402, thus reducing the weight, heat profile, and form factor of eyewear device 2402 overall while allowing eyewear device 2402 to retain its desired functionality. For example, the wearable accessory device can allow components that would otherwise be included on eyewear device 2402 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 2402 standing alone. Because weight carried in the wearable accessory device can be less invasive to a user than weight carried in the eyewear device 2402, a user may tolerate wearing a lighter eyewear device and carrying or wearing the paired device for greater lengths of time than the user would tolerate wearing a heavier eyewear device standing alone, thereby enabling an artificial-realityenvironment to be incorporated more fully into a user's day-to-day activities.

AR systems can include various types of computer vision components and subsystems. For example, AR system 2400 and/or VR system 2510 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 25A and 25B show VR system 2510 having cameras 2539A to 2539D, which can be used to provide depth information for creating a voxel field and a two-dimensional mesh to provide object information to the user to avoid collisions.

In some embodiments, AR system 2400 and/or VR system 2510 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 2400 and/or VR system 2510, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
forming a polymer thin film; and
inkjet printing a liquid crystal polymer solution over the polymer thin film to vary a thickness layer of the polymer thin film for modeling polarization properties of a human eye.

2. The method of claim 1, wherein inkjet printing the liquid crystal polymer solution allows for a localized patterning of a fast axis.

3. The method of claim 2, wherein the localized patterning of the polymer thin film models a birefringence distribution of the human eye.

4. The method of claim 1, wherein the polymer thin film comprises a polymer selected from the group consisting of polyethylene naphthalate, polyethylene terephthalate, polybutylene terephthalate, polytetrafluoroethylene, polyoxymethylene, aliphatic or semi-aromatic polyamides, ethylene vinyl alcohol, polyvinylidene fluoride, isotactic polypropylene, and polyethylene.

5. The method of claim 1, wherein the liquid crystal polymer solution comprises poly(ethylene glycol) (PEG), poly(propylene glycol) (PPG), poly(tetrahydrofuran) (PTHF), poly(dimethylsiloxane) (PDMS), poly(methylphenylsiloxane) (PMPS).

6. The method of claim 1, wherein inkjet printing further comprises modeling a non-uniform polarizing behavior of the human eye.

7. The method of claim 1, wherein the polarization properties further comprise retardance and diattenuation.

8. The method of claim 1, wherein the polymer thin film thickness is between at least approximately 100 nm and at least approximately 20 microns.

9. The method of claim 1, wherein the polymer thin film further comprises modeling scattering such as haze of the human eye.

10. The method of claim 1, wherein inkjet printing further comprises adding in a dichroic dye to the liquid crystal polymer solution to model the polarization properties of retardance and diattenuation.

11. A method comprising:
thermo-forming a functional optical layer to a specified shape; and
depositing a layer of a resin composition over a surface of the shaped functional optical layer to form a compound lens.

12. The method of claim 11, wherein the functional optical layer comprises a reflective polarizer and an optical retarder.

13. The method of claim 11, wherein the depositing comprises 3D printing.

14. The method of claim 11, wherein during the depositing an average droplet size of the resin composition is at least approximately 500 nm.

15. The method of claim 11, wherein the resin composition comprises a UV curable compound.

16. The method of claim 11, further comprising irradiating, for curing, the layer of the resin composition.

17. A method, comprising:
exposing an array of detectors in a photosensitive layer;
detecting a circular object via the array of detectors;
collecting an optical output signal from each detector through a corresponding optical fiber;
converting the optical output signal from each optical fiber into an electrical signal; and
determining a gaze direction of a user's eye based on the electrical signal.

18. The method of claim 17, wherein each optical fiber is a telecommunication fiber embedded within the photosensitive layer.
